(19) United States
(12) Patent Application Publication
(10) Pub. No.: US 2009/0125332 A1
(43) Pub. Date: May 14, 2009

(54) AUTOMATED EXECUTION OF HEALTH CARE PROTOCOLS IN AN INTEGRATED COMMUNICATIONS INFRASTRUCTURE

(75) Inventor: Marcia R. Martin, Erie, CO (US)

Correspondence Address: PATTON BOGGS LLP, 1801 CALFORNIA STREET, SUITE 4900, DENVER, CO, 80202, US

(73) Assignee: Magpie Healthcare, LLC, Westminster, CO (US)

(21) Appl. No.: 12/243,196

(22) Filed: Oct. 1, 2008

Related U.S. Application Data
(60) Provisional application No. 60/987,306, filed on Nov. 12, 2007.

(51) Int. Cl. G06Q 50/00

(52) U.S. Cl. 705/3; 705/2

(57) ABSTRACT

Automated execution of health care protocols in an integrated communications infrastructure is described. In one aspect, a computing device receives data from one or more of the remote computing devices, telecom devices, or executing health care protocols. The computing device then determines if the received data is a health care protocol triggering event. If so, the computing device identifies a standard of health care based protocol expression mapped to the triggering event, and instantiates (i.e., executes or automates) a protocol having the contextual characteristics of the mapped protocol expression and the triggering event. The automated protocol implements a set of actions associated with providing health care to a patient. If the received data is determined not to be a health care protocol triggering event, the computing device dispatches the received data to any executing health care protocol that previously registered to receive such input.

### RELATED APPLICATIONS

This patent application claims priority to U.S. Provisional Patent Application Ser. No. 60/987,306 filed on Nov. 12, 2007, titled “Communication Enabled Health Care”, which is hereby incorporated by reference.

### BACKGROUND

Using standards of health care codified in the form of algorithmic procedures (protocols) is common to most hospital nursing practices. Protocols may include instructions for carrying out evidence-based industry-standard patient-care regimens, or they may simply embody a particular hospital's policies and procedures. A protocol may include, for example, all types of information and steps such as who should be notified when a particular situation or event is discovered, policies about what discretionary actions may be taken by nurses in certain situations without the approval of a physician, instructions to doctors and nurses about how to administer a test or drug, lists of observations that should be charted, etc. Additional standard of care protocol examples include, for example, steps to check a patient's vital signs, administer a drug, perform a laboratory test, notify an attending physician, send an order to a pharmacy or blood bank, page an emergency responder, and/or so on. Today, most protocols are recorded on paper and executed manually. Frequently-employed methods in today's hospitals for making protocols known and accessible to caregivers are: storing them in 3-ring binders, placing them on laminated reference cards carried by nurses and emergency responders, and posting them on the walls in specialty stations such as the cardiac and trauma units in an emergency department.

### SUMMARY

Automated execution of health care protocols in an integrated communications infrastructure is described. In one aspect, a computing device receives data from one or more of the remote computing devices, telecom devices, or executing health care protocols. The computing device then determines if the received data is a health care protocol triggering event. If so, the computing device identifies a standard of health care based protocol expression mapped to the triggering event, and instantiates (i.e., executes or automates) a protocol having the contextual characteristics of the mapped protocol expression and the triggering event. The automated protocol implements a set of actions associated with providing health care to a patient. The computing device also dispatches the received data to any executing health care protocol that previously registered to receive such input.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows an exemplary system for online rules-based execution of standard of care protocols in an integrated and networked communications infrastructure, according to one embodiment.

FIG. 2 shows an exemplary set of network relationships for automated execution of health care protocols in an integrated communications infrastructure, according to one embodiment.

FIG. 3 shows further exemplary details of health care management server 102 of FIGS. 1 and 2 for online rules-based execution of standard of care protocols in an integrated and networked communications infrastructure, according to one embodiment.

FIG. 4 shows an exemplary hierarchical representation of a resource model for a set of logical and physical resources, according to one implementation.

FIG. 5 illustrates an exemplary legend of constructs and rules for visually presenting operational flow and data aspects of protocol expressions, according to one embodiment.

FIG. 6 shows an exemplary protocol expression for a stat medication order protocol, according to one embodiment.

FIG. 7 shows an exemplary protocol expression for medication orders, according to one embodiment.

FIG. 8 shows another exemplary protocol expression (finite state automaton pattern) for laboratory result processing, according to one embodiment.

FIG. 9 shows an exemplary procedure for automated execution of health care protocols in an integrated infrastructure, according to one embodiment.

FIG. 10 illustrates further exemplary operations of procedure 900 of FIG. 9 for automated execution of health care protocols in an integrated communications infrastructure, according to one implementation.

### DETAILED DESCRIPTION

### Overview

Automated Systems Typically Bypassed in Favor of Manual Systems

Graphical user interfaces (GUIs) associated with conventional EMR systems generally fail to collect and present relevant information to nurses in a manner that both facilitates rapid data access and keeps pace with the rate at which chartable events occur during patient-care procedures. As a result, frontline caregivers (e.g., charge nurses, supervisors, staff nurses, medical technicians in nursing units such as Labor and Delivery, Emergency, and Intensive Care, etc.) often perceive automation as an impediment, and computer systems are often not used in “real time” situations. One reason for this is because sustainable velocity of the man-machine and machine-man interfaces of conventional systems for information retrieval, decision support, charting (data entry), etc., is generally far slower than the rate of real-world events and corresponding necessary response times. In view of this, frontline caregivers often bypass automated methods for common health care-related tasks in favor of ad hoc manual methods. Such reliance can be detrimental, however, as it presents opportunities for introducing human error as handwritten notes are transcribed after the fact into automated systems. Additionally, the duplication of effort involved in such transcriptions takes time that caregivers would otherwise spend actually caring for patients.

One limitation, for example, is that manually retrieving and implementing protocol(s) in face of a real time event may actually be more time consuming and less reliable than if a reliable failsafe automated technique for obtaining, distributing, and implementing the protocol(s) were available. As a real time health care event unfolds, the caregivers will generally determine next protocol steps to take from memory and verify completed protocol steps by word-of-mouth and by recording chartable data on handwritten notes that will likely not be transcribed into any electronic system or database until a later time. Such reliance may result in protocol steps being implemented out of order, performed too late, or even completely overlooked. Moreover, important handwritten notes may not be timely or ever entered into appropriate database(s) for later reference. As a result, manually locating, distributing, and implementing health care-based protocols may jeopardize data integrity and negatively impact the ability of caregivers to provide desired standards of care to patients.

Lack of a Unified Communication System for Health Care Environments

Communication systems such as those connected via Private Branch Exchanges (PBX), a public switched telephone network (PSTN), and local and wide-area networks (LANs and WANs) are common to modern health care facilities. Modern unified communication architectures mean that the PBX internal telephone network, its gateway to the PSTN, the hospital's Internet portal, and all of the hospital's computer software applications such as EMR, patient monitoring, and human resources, are accessed by and communicate upon the same local-area-network that is the backbone of the institution's communication infrastructure. This presents the opportunity for unprecedented levels of integration.

However, today, despite the presence of a physical network infrastructure that supports it, the several LAN-based applications that a typical hospital employs cannot automatically identify, contact (e.g., autodial via the PBX), and direct a qualified and available care provider to a particular patient location responsive to a health care event input into the EMR, where the event pertains to the patient. Analogously, other independent hospital systems used to independently provide support for implementation of health care-based protocols (e.g., nursing unit whiteboard devices, hospital call systems such as dedicated wireless handsets, etc.) are unable to leverage information detected, input, or otherwise known to one application to drive business processes controlled by another application, despite their sharing a common communications infrastructure.

Another exemplary limitation due to lack of an integrated communications infrastructure in existing health care facilities is that nurse assignment workloads and other critical information is not updated in real time across various information presentation sources and repositories such as an EMR system, nursing whiteboards, etc. Typically, whiteboards are integrated with one system, which is typically the EMR or the admissions system, and perhaps both if the hospital is using a comprehensive software product. The failure of such integration is that the most significant communication events—nurse-calls by patients, emergency phone calls by attending nurses, “code” conditions and the responses to them, etc.—are not integrated with whiteboards, causing whiteboard information to lag far behind events. Whiteboards display information manually entered into computer systems such as admissions, pharmacy (CPOE), and EMR.

Manual data entry operations are time consuming and prone to human error. This generally means that the assignment workload of nurses and other critical information typically is not updated in real time. On a busy day, such data transfer operations can be delayed for hours. This makes it difficult to determine who should respond to an emergency situation, of those who should respond to the situation, who is actually available to respond, of those available to respond, who is responding to the situation, etc. As a result, in “Code” level emergencies, for example, a commonly reported pattern is that all nurses in the area who can respond do so, and then leave if they are not needed. Clearly, this is not an efficient or reliable use of resources.

In yet another example illustrating limitations due to lack of a unified hospital communications infrastructure with the hospital's network, hospital nursing units often create and maintain paper records for patients for reference by doctors, nurses, staff, and/or so on, across working shifts. Such paper records are often stored in three-ring binders, and include, for example, doctors' orders, handwritten charts, notes, pharmacy and lab events, etc. Commonly, the information in such paper records is not transferred into the EMR system until after occurrence of relevant patient care events, and often such input does not occur until after a patient is discharged from the hospital. Moreover, even if information stored in a nursing unit's paper records is input into the EMR, a desk technician typically still has to print and fax any pharmacy orders for prescription fulfillment.

### An Exemplary System

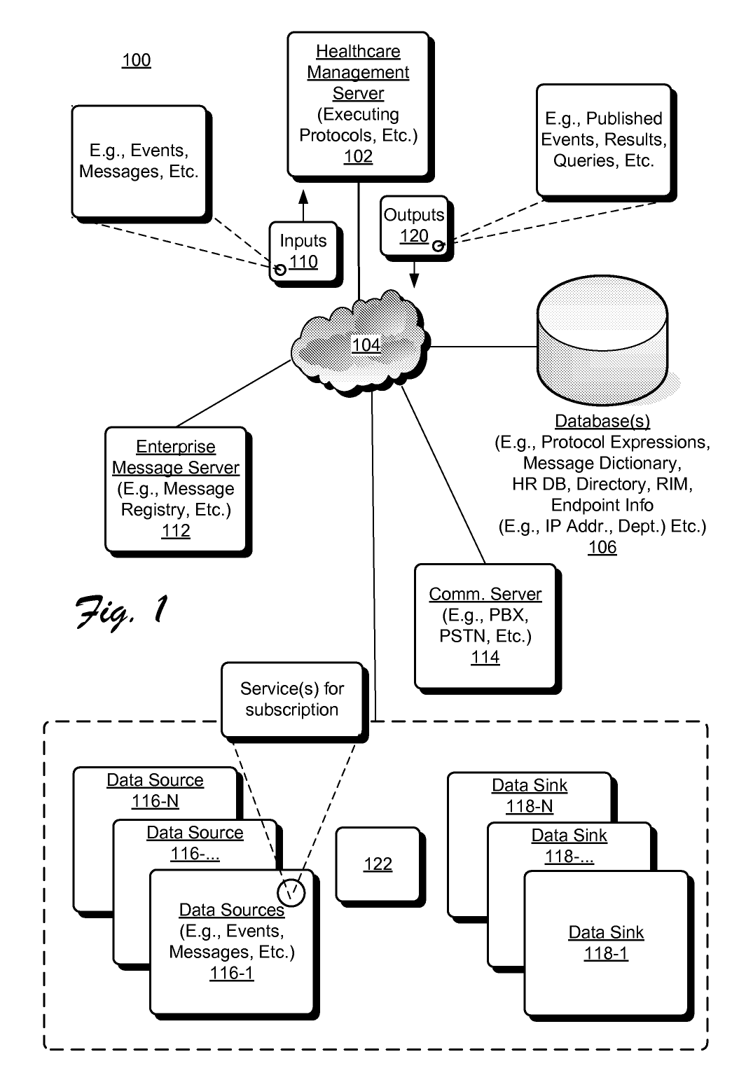

We now describe systems, methods, and apparatus for automated execution of health care protocols in an integrated communications infrastructure with respect to FIGS. 1 through 10. These systems, methods, and apparatus address the limitations described in the above background and overview sections of existing systems to provide patients with standards of health care. Although not required, automated execution of health care protocols in an integrated communications infrastructure, according to one embodiment, is described in the general context of computer program instructions executed by one or more computing devices. Computing devices typically include one or more processors coupled to data storage for computer program modules and data. Such program modules generally include computer program instructions such as routines, programs, objects, components, etc. for execution by a processor to perform particular tasks, utilize data, data structures, and/or implement particular abstract data types. While the systems and methods are described in the foregoing context, acts and operations described hereinafter may also be implemented in hardware.

FIG. 1 shows an exemplary system 100 for online rules-based execution of standard of care protocols in an integrated and networked communications infrastructure, according to one embodiment. The rules-based execution is provided by protocol expressions that objectively optimize real time automation of health care protocols responsive to dynamically detected and selectively generated health care-based events. To these ends, the systems and methods implement an event/message driven and standards-based messaging model to achieve inter-application operability, and thereby integrate diverse and arbitrary combinations of devices and systems with available computer and telecommunications networks (e.g., LANs, Wide Area Networks (WANs), the Internet, intra and extranets, and/or so on). Such devices and systems include, for example, at least a subset of mobile and desktop computers, institutional wireless handsets, pagers, nurse call systems, public and institutional wired and wireless telephone networks, EMR systems, messaging interfaces, departmental whiteboard devices, private mobile telephones used by doctors and other caregivers, support devices (e.g., for diagnostics, monitoring, information presentation, etc.), and other facility equipment and systems. Information associated with the automation is validated and presented in substantially optimal data formats on target devices/mediums to health care providers.

In this exemplary implementation, system 100 includes health care management server 102 operatively coupled over network 104 to one or more databases 106 and remote computing devices such as enterprise messaging server 112, communication server 114, data sources 116 (e.g., 116-1 through 116-N), and data sinks 118 (e.g., 118-1 through 118-N). Health care management server 102 represents, for example, any one or more of a server, a general purpose computing device such as a server, a personal computer (PC), a laptop, and/or so on. Networks 104 represent, for example, local area network(s) such as a hospital intranet, the Internet, wide area network(s), public and/or private telephone exchanges (e.g., PBXs and PSTNs), and/or so on. Such networking environments are commonplace in offices, enterprise-wide computer networks, intranets, and the Internet. Data sources 116 and data sinks 118 represent a set of arbitrary computing devices executing application(s) that respectively send data inputs (e.g., data inputs 110) to health care management server 102, or receive data outputs (e.g., data outputs 120) from health care management server 102. Such computing devices include, for example, one or more of medical devices (e.g., monitoring and/or analytical devices), nurse call systems, public address systems, departmental whiteboards, messaging systems, data capture devices, wired and wireless telephones/handsets, pagers, mobile computing devices (e.g., PDAs), server computers, desktop computers, laptops, corresponding computer software application(s) such as e-mail, and/or so on.

A data source 116 executes a computer program (application) that sends data inputs (e.g., at least a subset of data in data inputs 110) to health care management server 102 via one or more of enterprise messaging server 112 and communication server 114. In this implementation, input data 110 (i.e., events or messages) arrive at health care management server 102 via a logical data path called a message queue. Many message queues may exist. A message may be a self-describing information packet or an object instance encapsulating a set of data and methods. Exemplary messages include, for example, orders for medications, lab tests, therapies, readings from patient monitoring equipment, laboratory results, charting(s) of caregiver observations, laboratory instrument readings, text messages (e.g., acknowledging receipt of an alert), and/or so on. An event is a measurable, recognizable occurrence detectable by a computer program. Exemplary events include, for example, receipt of a message, timer expiration, protocol completion, and/or so on.

A data sink 118 executes application(s) that receive data output (e.g., at least a subset of data in data outputs 120) from health care management server 102. Such applications(s) may be the same or different than the programs executing on a data source 116. Examples of such applications include HL7 compliant (or other) applications, Electronic Medical Records systems (EMR), pharmacy order processing and drug dispensing applications, physician order entry (CPOE) programs, patient monitoring systems, etc. Although data sources 116 and data sinks 118 are illustrated as independent entities, and because a program/application executing on a remote computing device may both send data and receive data respectively to/from health care management server 102, a data source 116 may also be a data sink 118. Component 122, for example, represents a computing device that serves as both a data source and a data sink.

In one implementation, health care management server 102 and at least a subset of data sources 116 and data sinks 118 use one or more of enterprise messaging server 112 and communications server 114 to facilitate bidirectional data communications of messages and events respectively to/from other components of system 100. Hereinafter, messages and events are collectively often (but not exclusively) referred to as “messages” or “events.” In one implementation, the enterprise messaging server implements Enterprise Service Bus (ESB) middleware that translates messages from a formal messaging protocol of a sender to a formal messaging protocol of a receiver. There are multiple known standards for encoding events and messages in health care workflows. These standards are generally not mutually exclusive. In one implementation, for example, at least a subset of inputs 110 and outputs 120 are based on the known Health Level Seven (HL7) messaging standard. In such an implementation, the HL7 compliant ESB delivers events from computer program applications (e.g., subscribe-to services such as an application executing on an EMR system, etc.) executing on respective ones of the data sources 116 and/or data sinks 118. In such a scenario, system 100 integrates networked devices such as nurse call systems and institutional wireless (WiFi) telephone networks together with EMR systems and other components/devices via HL7 interface standards. In one implementation, system 100 provides a prose manual or message dictionary to specify various message formats. In one implementation, the message dictionary is specified via Extensible Markup Language (XML) in one or more of a Document Type Definition (DTD), a schema, a serial delimiter based mechanism (e.g., HL7's mechanism), and/or so on.

In this implementation, the ESB utilizes known interfaces to allow administrators and computer program applications to map certain data sources 116 and/or data sinks 118 (e.g., publishers and subscribers) to specific events or messages and corresponding message queues. The ESB maintains respective message queues for event/message communications between particular ones of the data sources and data sinks. These mappings are maintained in a global registry of message queues, which is shown in FIG. 1 as “Message Registry”, to support message exchanges. The message registry is a table of message queues available to health care protocols executing on health care management system 102. Each entry in a message registry contains at least the name of a message queue and a definition of the types of messages/events that subscribers may expect to receive from the queue. In this implementation, the ESB exposes an interface allowing health care management server 102 to discover and subscribe to available services exposed by respective publishing data sources.

The communications server 114 provides wired and/or wireless data communications between health care management server 102 and telecommunications devices over any combination of private and public telecom networks (e.g., a PBX and a PSTN). In this context, the telecommunications devices (e.g., wired and wireless telephones, fax machines, modems, and/or so on) represent at least a subset of the data sources 116 and/or data sinks 118. Techniques to convert data from/to a PSTN or a PBX to/from an Internet Protocol (IP)-based network such as an Intranet are known.

In one implementation, and rather than directly communicating data to/from health care management server 102 respectively from/to the sources 116 and/or sinks 118, communication server 114 implements a Service-Oriented Architecture (SOA) interface to map and communicate information received from a telecom device (a data source 116) to the ESB capabilities provided via the enterprise messaging server 112 for subsequent distribution via the described messaging engine middleware to health care management server 102. In this scenario, the SOA of the communication server 114 also maps data inputs (e.g., SMS text messages) from health care management server 102 (via the enterprise messaging server 112) to an appropriate data format for processing by one or more target receiving telecom devices.

In one implementation, operations for automated execution of health care protocols in an integrated communications infrastructure are implemented at least in part in layer 7 of the well-known Open Systems Interface (OSI) reference model. The administrative layer of the hospital's PBX, its EMR system, its patient monitoring systems, its billing system, its HR systems and time clock, are all layer 7 applications. Individual hospitals may do custom application development to integrate these applications with one another, usually in a simple way by simply transferring data from one application to another, but failing that, the applications are not integrated at layer 7. In contrast to known systems, the operations of system 100 integrate the applications in real-time at layer 7 to unify their respective contributions in support of a single business process—the protocol. The Enterprise Service Bus performs activities at OSI layers 4-6, presenting a very intelligent service interface to applications residing at layer 7. For this reason, an ESB is sometimes referred to as a layer 7 switch.

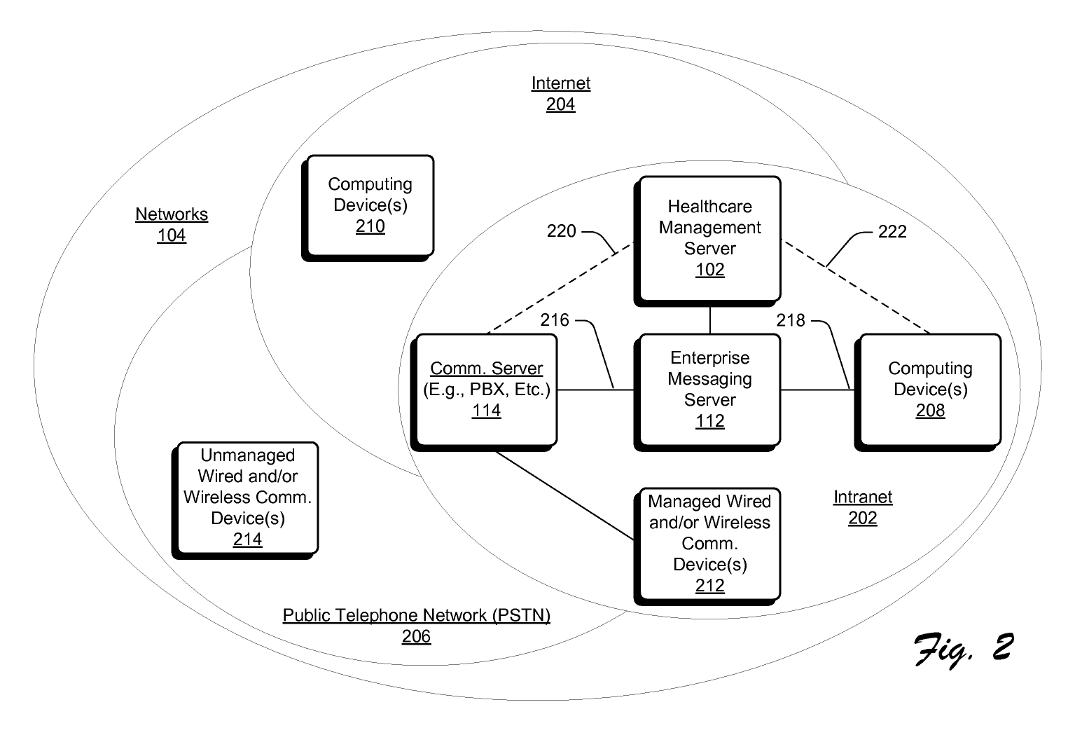

FIG. 2 shows an exemplary set of network relationships for automated execution of health care protocols in an integrated communications infrastructure, according to one embodiment. For purposes of exemplary reference and description, the first numeral of a component reference number is indicative of the particular Figure where the component was first introduced. For example, referring to FIG. 2, the first numeral of reference number 104 is a “1”, indicating that network 104 was first introduced in FIG. 1. Referring to FIG. 2, there is shown that network 104 includes, for example, an intranet 202, Internet 204, and PSTN 206. Intranet 202 represents, for example, a health care facility's private computer network that uses Internet protocols (e.g., IP) and network connectivity to securely share part of the organization's information or operations with its employees, contractors, and/or so on. In this implementation, the intranet comprises health care management server 102, enterprise messaging server 112, communications server 114, computing devices 208, and managed wired and/or wireless communication device(s) 212.

Solid lines 216 and 218 represent communication pathways that respectively indicate that one or more of communications server 114 and a computing device 208 may send/receive data (e.g., inputs 110/outputs 120 such as standardized events and queries, etc.) to/from health care management server 102 via enterprise messaging server 112. Dotted lines 220 and 222 represent communication pathways that respectively indicate that one or more of the communications server 114 and the computing device 208, in one exemplary implementation, may also send/receive data (e.g., inputs 110/outputs 120 such as voice data, e-mail, text messages, etc.) to/from health care management server 102 independent of enterprise messaging server 112. In this implementation, managed wired and/or wireless communication device(s) 212, which are also referred to as “endpoints”, include, for example, any telecommunications device that can be managed via communication server 114 (e.g., a PBX, where device(s) have internal extension(s)). Such managed endpoints may include, for example, traditional wired phones, desk consoles that include soft keys and text displays, computer-based soft phones, and institutional wireless (WiFi) mobile phones.

Internet 204 comprises computing devices 210 that may send and/or receive data (inputs 110 and/or outputs 120) respectively to/from health care management server 102 (e.g., via e-mail, SMS text messaging, etc.). PSTN 206 comprises unmanaged wired and/or wireless communication device(s) 214 that may send and/or receive data (inputs 110 and/or outputs 120) respectively to/from health care management server 102 (e.g., voice data, e-mail, SMS text messages, etc.). An unmanaged wired and/or wireless communication device (endpoint), for example, is typically a phone or other communication device that is not part of the health care facility's hospital/institution's internal telephone network served by a PBX (please see communication server 114). Unmanaged endpoints include, for example, a doctor's PDA, a cellular phone, a home phone, or an office phone. Collectively, computing devices 208 and 210, and managed and unmanaged telecom-type endpoints 212 and 214 represent respective ones of data sources 116, data sinks 218, and/or composite devices 122 (i.e., data sources and sinks).

Exemplary Health Care Management Service

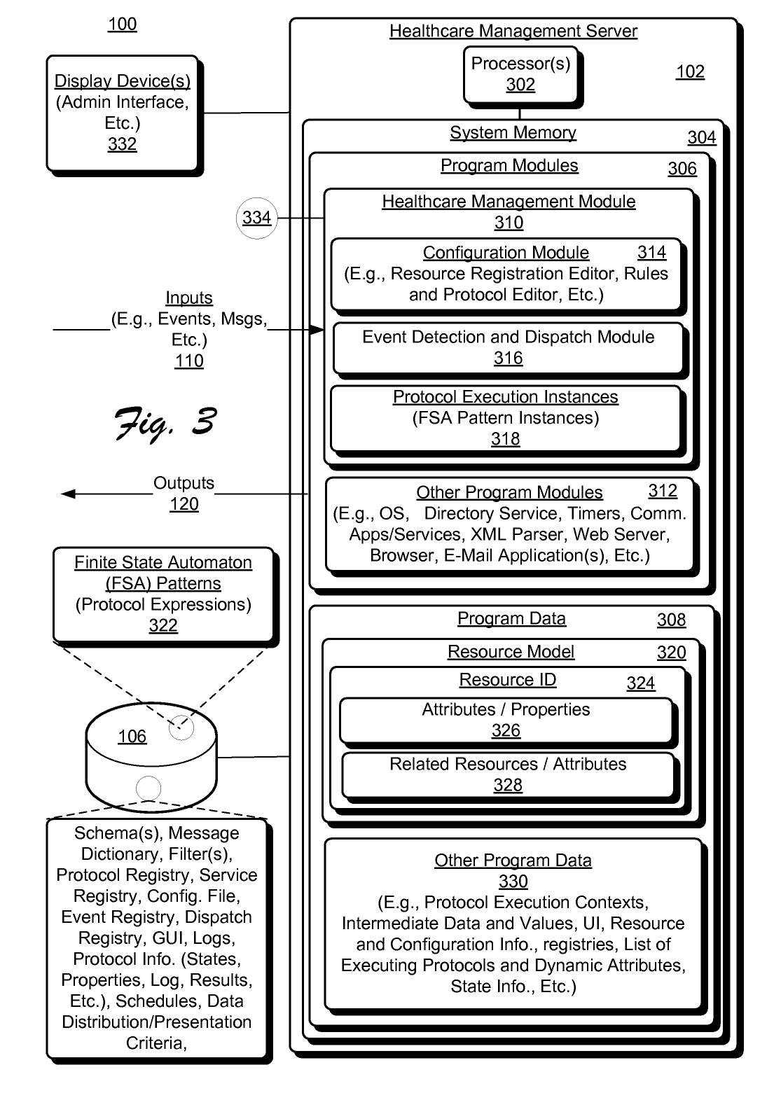

FIG. 3 shows further exemplary details of health care management server 102 of FIGS. 1 and 2 for online rules-based execution of standard of care protocols in the integrated and networked communications infrastructure of system 100, according to one embodiment. As shown, health care management server 102 includes one or more processors 302 coupled to system memory 304. The system memory represents a tangible computer-readable data storage memory such as volatile random access memory (RAM) and non-volatile read-only memory (ROM). System memory 304 includes program modules 306 comprising computer program instructions executable by processor(s) 302, and program data 308 generated and/or used by respective ones of the program modules. Program modules 306 include, for example, health care management module 310 and other program modules 312. Health care management module 310 includes program logic to implement a rules-based event/message driven model that automates health care-based protocol(s) responsive to receiving data inputs 110 from respective ones of data sources 116. Other program modules 312 include, for example, an operating system to provide a runtime environment, device drivers, network communication applications/services, timers, and/or other applications (e.g., e-mail and/or messaging applications, a Web server, a Web browser, timers, a markup language parser, etc.).

In this exemplary implementation, health care management module 310 includes configuration module 314, event detection and dispatch module 316, and protocol execution instance(s) 318. In this implementation, for example, configuration module 314:
(a) provides an administrative resource mapping interface through which an administrative entity can create a model of interrelationships (shown as resource model 320) describing the physical and logical resources of a health care facility—respective ones of at least a subset of the physical and logical resources affecting operations, or being used to implement operations of automated health care protocol executions;
(b) provides an administrative protocol editing interface through which an administrative entity can create and/or edit Finite State Automaton (FSA) patterns 322 describing context (i.e., characteristics such as health care protocol triggering event(s), messages to be received/processed by the protocol, actions, data contexts, etc.) of respective health care protocols (each FSA pattern is a protocol expression used to provide an instantiated protocol (a protocol execution instance 318) with context);
(c) discovers and subscribes to services published by respective data sources 116; and
(d) maps triggering message(s)/event(s) published from subscribed-to services to specific FSA pattern(s) 322.

Event detection and dispatch module 316 receives data inputs 110 published from at least a subset of the subscribed-to services executing on corresponding ones of data sources 116. Responsive to receiving such data inputs, if the data inputs include a predetermined triggering event, event detection and dispatch module 316 identifies the corresponding protocol expression to create/instantiate corresponding protocol execution instances 318 (executing protocols) to provide standards of health care within a health care facility. Data inputs are also dispatched to any already executing protocols that previously expressed interest in receiving such input. These and other aspects of health care management server 102 are now described in greater detail in the sections titled “Exemplary System Configuration”, “Exemplary Protocol Expressions”, “Exemplary Service Discovery And Subscription”, “Exemplary Event Dispatch”, “An Exemplary Procedure”, and “Exemplary Health Care Protocol Use Cases.”

### Exemplary System Configuration

Configuration module 314 automatically and/or responsive to events or user inputs identifies physical and logical resources and corresponding resource properties/attributes of system 100 and models their interrelationships to generate resource model 320. Physical resources include, for example, staff, computing devices, telecommunications endpoints (e.g., telephones, handsets, facsimile machines, etc.), patients (inpatients and outpatients), nursing unit whiteboards, PDAs, services (e.g., pharmacy, blood banks, etc.), rooms, beds, protocols, rule sets, etc. At least subsets of these physical resources identify respective data sources 116 and/or data sinks 118. Logical resources include, for example, departments, nursing units, organizational hierarchies, user accounts that grant application access to individuals, work schedules, etc. In this implementation, configuration module 314 assigns each identified resource a unique resource ID 324.

At least a subset of resources specified via resource model 320 are associated with a set of arbitrary properties or attributes 326 (which may be corresponding resources), and a listing of related resources/attributes 328. For example, a person may have one or more of the following attributes: a role or roles within which the person may work (e.g., patient, doctor, nurse, administrator, etc.), a location associated with the individual (e.g., room, bed, city, building, etc.), an assigned department, a set of privileges, a working schedule, contact information (e.g., e-mail addresses, telephone numbers, extensions, etc.), computer-based accounts, corresponding electronic files/records, and/or so on. In another example, a computing device may have one or more of the following attributes: an IP address, a physical location, user accounts, an administrator and/or department assigned to the device, a device type or model, and/or so on.

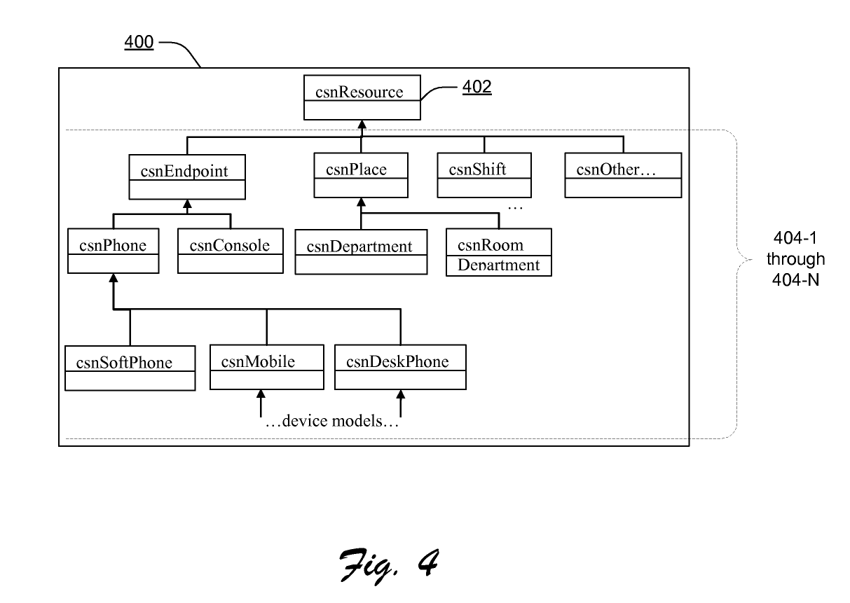

FIG. 4 shows an exemplary hierarchical representation 400 of a resource model for a set of logical and physical resources, according to one implementation. Such resource interrelationships include, for example, organizational hierarchy of a health care facility, mapping of locations, telecommunications devices, other resources to the hierarchy, mapping of policies to objects in the hierarchy (e.g., patient phones can't initiate certain protocols, etc.), and/or so on. The exemplary illustration of FIG. 4 shows that resources 404-1 through 404-N relate to resource 402. In this example, “csn” represents “communications support for nursing”, which is one of many possible health care facility based uses of system 100. In this mapping, resources (“csnResource”) are mapped to communication endpoints (“csnEndpoint”), locations (“csnPlace”), working shifts (“csnShift”), and other mappings (“csnOther”). As shown, the communication endpoints include, for example, phones (e.g., soft phones, mobile phones, and desk phones) and consoles. The locations include, for example, departments and rooms. In another implementation, such resources are related in different manner. Such mappings can be arbitrary and are typically a function of organizational hierarchies, available resources, and/or so on.

Referring to FIG. 3 and one implementation, for example, static portions of a health care facility's resource model 320 include:
a list of departments;
a mapping of Internet protocol (IP) phones (wired and/or wireless) associated with (e.g., owned, leased, etc.) the facility to departments;
a mapping of room numbers and other location codes within the facility to departments;
location codes of non-mobile phones;
roles within which people may work;
roles that departments utilize;
people that work in or are associated with the hospital;
people that have contract lists, roles that they are authorized to work in, and departments that they are authorized to work in;
accounts that grant user access to the health management server application;
and/or so on.

Dynamic portions of resource model 320 can be changed, for example, via an administrative interface (e.g., a resource registration editor provided by configuration module 318) or via data sources 116 (e.g., via predetermined user inputs such as key sequences communicated to health care management module 310, etc.). Dynamic portions of the model include, for example, working schedules, entity availability (e.g., present, busy, etc.), roles assigned to individuals and/or departments, mapping of individuals to phones (e.g., handsets/phones can be checked in and checked out), etc. Examples of an end user registering as a resource and/or changing attributes associated with a corresponding resource are presented below in the section titled “Exemplary Resource And Attribute Definition And Update.”

In one implementation, configuration module 314 allows an administrative entity to specify and/or edit resource model 320 indicating registered resources, institutional policies, granting privileges to users, and/or so on. Such specification and/or editing can be provided, for example, by presenting a resource registration editor on a display device 132 to provide definition of location resource hierarchies or collections such as departments and nursing units, assigning telephony resources to departments, aliases to telecom devices, shift directory specifications, etc. Exemplary shift directory specifications include, for example, indications of names of staff members that have checked in, scheduled arrival and departure times, external contact preferences and priorities (e.g., text alert to registered endpoint, SMS text alert to personal mobile device, text alert to alphanumeric pager, send phone number to numeric pager, e-mail, call primary number, call secondary number, etc.), primary roles, any secondary roles, speed dial codes, and/or so on. In one implementation, the resource registration editor further allows the administrative entity to indicate which resources are related to other resources and/or attributes (e.g., via drag-and-drop operations, text editing, etc.).

Such resource interrelations (related resources/attributes 328) include, for example: (a) assigning a nurse and/or a set of protocols (e.g., health care protocols, protocols for other situations such as bomb threats, abductions, fires, etc.) to a department; (b) assigning telephony resources to departments and/or individuals; (c) assigning active roles and responsibilities to individuals; (d) specifying locations of resource hierarchies or collections such as departments and nursing units; and/or (e) etc. In one implementation, resources and resource attributes are represented in resource model 320 according to a predefined schema. For purposes of exemplary illustration, such a schema is shown as a respective portion of “other program data” 330. In one implementation, configuration module 314 allows an entity to modify information corresponding to resource model 320 via a telecom device such as a telephone, via a console external to health care management server 102, via a web service, and/or so on.

In one exemplary implementation, configuration module 314 automatically identifies health care facility resources and their corresponding interrelationships when generating resource model 320. To these ends, configuration module 314 queries one or more information sources, for example, such as: (a) a protocol registry to determine protocols pertaining to the health care facility, a department, an individual, etc.; (b) an EMR database (e.g., to obtain role-based contact information, role-based physician contacts for individual patients, information from patient records that drives decision points in protocols [e.g., drug allergies, age, weight, gender, blood type, medications taken, etc.], protocols and order sets already defined in a hospital records system, etc.); (c) a human resources database and/or Directory Service(s) indicating, for example, health care facility employees, contractors, roles, etc.; (d) an HL7 Reference Information Model (RIM); (e) communications server 114 (e.g., a PBX/Communications Management Service) to determine telecom device endpoints and corresponding attributes; and/or (f) etc. In one exemplary implementation, configuration module 314 exposes an Application Programming Interface (API) 334 allowing a computer program to automatically register resource(s) and indicate any resource interrelationships via the interface.

Console Configuration

In one implementation, configuration module 314 evaluates a configuration file to identify a set of console rules to configure health care management server 102. Such console rules are shown as a respective portion of “other program data” 330. In one example, health care management server 102 is configured to respond to a particular set of inputs 110 as a function of one or more of a set of privileges mapped to a location (e.g., institutional or department privileges) of computing device 102, a set of privileges associated with a role of a specific person logging onto the computing device (e.g., Labor and Delivery Nurse as compared to a neurology surgeon), etc. In one example, if the health care management server 102 is located in the Labor and Delivery department, the health care management server may be configured to respond to inputs 110 that are related to that departmental practice, and not to respond to inputs 110 associated with a different department.

### Exemplary Protocol Expressions

Before discussing service discovery and subscription operations of configuration module 314, operations which in turn allow the system to map corresponding service events to desired protocol executions, we first describe exemplary aspects of Finite State Automaton (FSA) patterns 322. One reason to discuss FSA patterns prior to discussing service discovery and service subscription operations is because the configuration module evaluates characteristics of each FSA pattern to identify a corresponding set and/or characteristics of published services of interest (e.g., EMR services, monitoring equipment services, etc.). Once particular services and/or service characteristics of interest have been identified, the configuration module can: (a) subscribe to corresponding services available in system 100 (the ESB middleware of enterprise management server 112 of FIG. 1 maintains a service registry of such services); and (b) generate a dispatch registry mapping triggering events of such services to appropriate FSA patterns 322 defining protocols. Regarding this latter item, and as described in greater detail below in the section titled “Exemplary Event Dispatch”, event dispatcher logic of health management server 102 searches the dispatcher registry to determine whether a protocol based on a particular FSA pattern should be started responsive to receiving an event from a subscribed-to service.

Each FSA pattern 322 is a set of statements/rules and data that define operational workflow, states, and data characteristics for a protocol associated with a medical standard of care. In at least these respects, each FSA pattern is an expression of a protocol. In one implementation, FSA patterns are stored on a relational database. A protocol implemented based on such a pattern may perform any number of different arbitrary types of operations including, for example, facilitating and monitoring interactions among individuals and automated systems in a health care environment, reacting to external events of arbitrary type on a network with classes of special events for implementation of health care protocols, etc. (A nonexhaustive set of exemplary health care based contexts and operations, for example, protocols based on corresponding FSA patterns, is provided below in the section titled “Exemplary Health Care Protocol Use Cases”). The operational workflow is a function of the particular architecture of an FSA pattern, which in turn is a function of the particular types of data inputs 110 (i.e., events/messages) the FSA pattern is designed to process. An FSA pattern, for example, may indicate who (e.g., individuals with specific roles, departments, services, etc.) should be notified responsive to a particular state or event, data sinks 112 (that may or may not be defined by dynamic resource attributes) to receive certain data/information responsive to a particular state or event, policies about what actions (e.g., discretionary) may be taken by nurses in particular situations (e.g., independent of approval of a physician), instructions about how to administer a test for a drug, list of observations that should be charted in real time, ensure that exceptions to workflow(s) are captured and/or properly handled, and/or so on.

In one implementation, for example, an FSA pattern 322 is designed to process at least EMR service inputs, wherein a triggering event (i.e., a protocol instantiation event) is an event corresponding to a patient being admitted into a health care facility. In one implementation, such information is specified using Business Process Execution Language (BPEL), XML, and/or so on.

An FSA pattern 322 may describe a protocol's characteristics via any one or more of a number of different arbitrary manners, for example, using Extensible Markup Language (XML), ASCII text, scripting languages, and/or so on. Each FSA pattern includes information that specifies the types of data inputs that it is designed to process. In this implementation, an FSA pattern may use an XML Data Type Definition (DTD), XML schema, or other syntax such as one based on HL7's well-known serial delimiter-based mechanism to extract values from data input(s) 110 directed to a corresponding executing protocol based on the FSA pattern. In one implementation, configuration module 314 provides a rules and protocol editor to allow an administrative entity to define and/or edit FSA pattern(s) 322, for example, via a GUI on a display device 132. In addition to allowing a user to define and customize expressions specifically directed to providing health care to an individual, such definition editing may further include defining protocols that are indirectly related to providing such health care to an individual. Such definition and editing may include, for example, defining and/or customizing institutional-scope protocols for system 100 (e.g., specifying rules for resource registration, writing protocols to address bomb threats, abductions, fires, etc.).

In one implementation, a user visually defines an FSA pattern 322 as a graph similar to a flow chart composed of nodes and directed arcs, where the nodes in the graph represent possible transitions of the automaton from one state to another. In one implementation, an administrator for a department or nursing unit uses the rules and protocol editor to edit only rules and protocols that are invoked exclusively by the corresponding department or nursing unit. In this example, doctors and resources outside of the department/nursing unit may be referenced by such protocols.

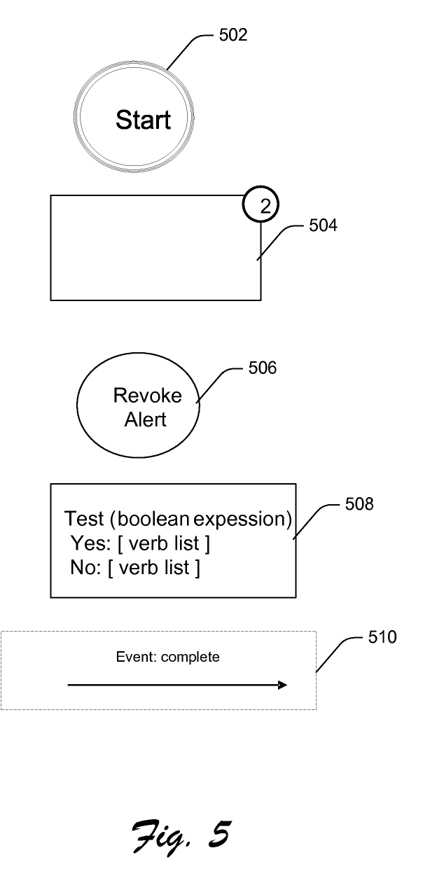

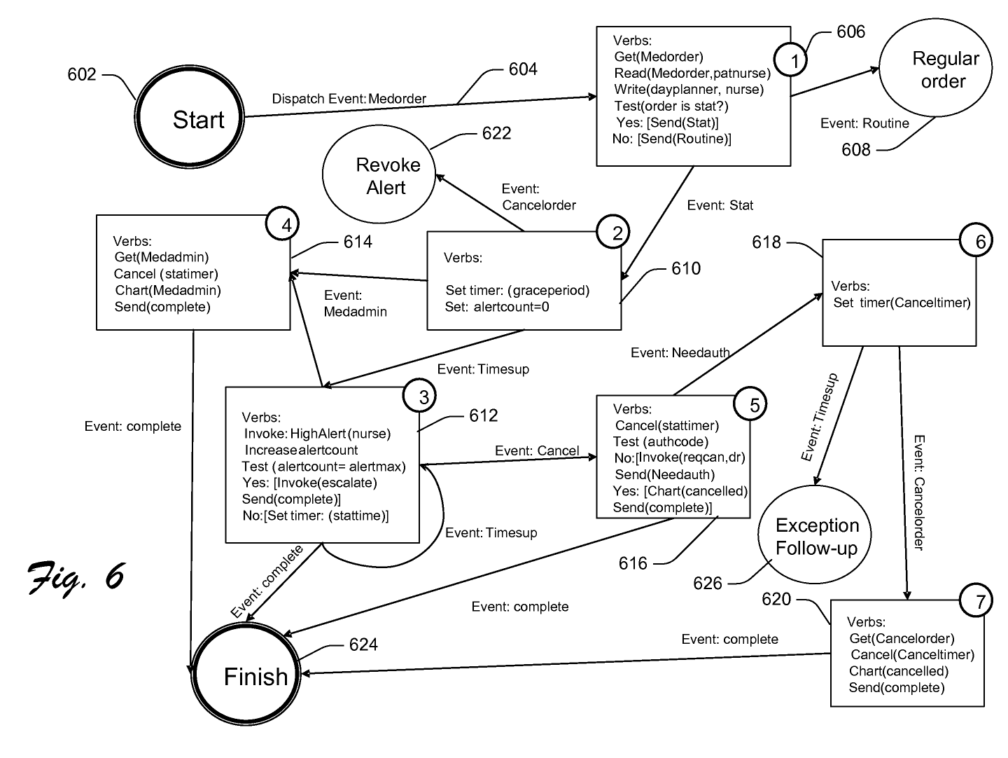

FIG. 5 illustrates an exemplary legend of constructs and rules for visually presenting operational flow and data aspects of FSA patterns 322, according to one embodiment. For purposes of exemplary illustration, such constructs and rules are used below to present a number of FSA patterns with respect to FIGS. 6 through 8. Referring to FIG. 5, circles with heavy borders, such as circle 502, indicate start and end states. In this implementation, every FSA pattern has exactly one start protocol state and one end protocol state. Additionally, each FSA pattern has an arbitrary number of intermediary protocol states in between the start and end states, the number of intermediary protocol states being a function of the particular FSA implementation. Each intermediate state represents one or more steps to be carried out in the implementation of a medical intervention or health-based protocol. That is, the protocol states represent only the steps which are either automated or which yield an automated result (e.g., an event) that an executing protocol may detect. Each state is connected by arcs with one or more other states. Each arc is labeled with an event. Each state is labeled with a set of verbs that are executed upon entry to the state.

A “verb” is based on parameterized information either collected during a previous rule step or coded during rule definition (e.g., via a rule and protocol editor) specifying an action that may be attempted by a protocol. Exemplary verbs include, for example, verbs for data collection such as “post <a form>”, “receive <a touchpad event>”, etc. Exemplary verbs for communication include, for example, “dial <a telephone number>”, “send <text to a handset with a text display>”, “send <a ring tone to a handset>.” Other exemplary verbs, for example, include “execute a rule <now>”, “schedule a rule to execute at a future time <based on parameterized information either encoded in the rule or collected during the previous step or computed by a combination of the two>.” Rules/statements, when executed, may inherit data collected from the context in which the rule was invoked, such as from another rule, a data collection form, a function key event, and/or so on.

Referring to FIG. 5, numbered boxes such as box 504 represent a respective FSA state that encodes an executing protocol's progress. An executing protocol's state is part of the protocol's execution context (an executing protocol in combination with its corresponding protocol data is the protocol's execution context). That is, the protocol's state represents a node in the corresponding FSA pattern 322 that, together with other information in the protocol's execution context, encodes/indicates the progress of the executing protocol. Protocol state can be expressed in a number of different arbitrary manners. In one implementation, for example, protocol state is expressed by a label (e.g. s1) together with a list of verbs to be executed upon entry to the state. Moreover, the “state” of an executing protocol is represented by the label of the state (as above) that the FSA is “in”. The state of an executing FSA is represented as simply “s1”, although the actual execution state of an FSA is “s1” plus the entire execution context of the FSA. For example, an FSA is in state S2 (a label) when it has taken an event arc directed at S2 and then executed all the verbs associated with S2. At that point, the executing protocol is in S2, and it waits “in S2” for one of the events associated with arcs originating at S2 to occur.

Verbs associated with a particular protocol state are executed before waiting for an event to transition the protocol to a different state. Exemplary verbs include, for example, verbs to send a message to a data sink 118, set a timer, cancel a timer, invoke another FSA pattern 322, subscribe to a service message queue, cancel a subscription, make a telephone call, transfer a telephone call, end a telephone call, send an alert, send an event or query, copy data from a message into a protocol's execution context, etc. Verbs in an FSA pattern, for example, may also provide for one or more of:
call consolidation (e.g., where one event yields multiple alerts via one or more media [e.g., based on a department's duty roster, established standards of care, user preferences, etc.]);
role and/or adaptive availability-based speed dialing (e.g. call an anesthesiologist who is not busy and keep calling anesthesiologists until one responds);
automated smart telephone dialing mechanisms (e.g., situational push-to-talk and conferencing among configurable groups of individuals [e.g., emergency responders, etc.], fast-access text directories on institutional mobile handsets, etc.);
alert mechanisms (e.g., proactive, exception-based, scheduled alerts, and adaptive alert routing based on configurable criteria [e.g., a group of possible responders based on workload or status, adapting to negative acknowledgment, expiration of a response time, contacting alternates, etc.]);
automated nursing unit whiteboard display updates (e.g., implemented via mobile handsets using location, presence, and situational inference information, etc., show up-to-date staff and patient status, etc.);
adaptive data mobility (e.g., timely placement of data on mobile handsets of targeted caregivers [e.g., orders, patient vital signs, alert responses, decision support information, etc.]);
automated charting (e.g., times of protocol invocation, alerts, responses, orders [e.g., sent, received, and filled], automatically update a nursing units' whiteboard display with protocol progress, etc.);
automatically provide a caregiver with an opportunity to approve/comment on observations (e.g., patient vital signs, etc.) via a handheld mobile device or other data source 116;
protocol support (e.g., automatically retrieve information to satisfy executing protocols from coupled databases, consolidate retrieved information for automatic display, etc.);
device-appropriate formatting (e.g., automatically format data based on capabilities of the display device [e.g., mobile device, computer display, and/or so on] on which the data will be displayed; and/or
etc.

Data sources 116, executing protocols, and/or other entities such as persons, agencies, etc. can trigger an event that causes an executing protocol to change state. Such events are arbitrary and may include, for example, a timer event, an event indicating issuance of a lab order for a patient, admission/discharge of a patient to/from a care facility, orders for patient transfers, medication prescriptions, new patient observations (e.g., lab results, vital signs readings, etc.), and/or so on.

Referring to FIG. 5 and shape 506, circles with light borders (as compared to circles with heavy borders such as circle 502) are not part of the FSA pattern but act as an indicator that part of an exemplary illustration of a respective FSA pattern is omitted or continued in a different figure/page. Referring to box 508, parentheses encapsulate parameter lists associated with a verb. In this example, the verb is “Test” and the parameter list is represented by “Boolean expression.” Square brackets “[. . . ]” encapsulate conditionally executed lists of verbs. Dotted line box 510 is not a construct utilized in the exemplary FSA pattern illustrations, but rather the dotted line box 510 surrounds a line segment, or “arc.” In this implementation, an arc represents a protocol's transition from one state to a different state. In this example, the arc is associated with a label that defines the event(s) received by the executing protocol, reception of which triggers state transition. In view of the exemplary FSA pattern legend criteria presented with respect to FIG. 5, visual illustrations of several exemplary FSA patterns are now described in FIGS. 6 through 8.

FIG. 6 shows an exemplary protocol expression for an immediate (i.e., a stat) medication order protocol, according to one embodiment. For purposes of description, aspects of the pattern are described as states (e.g., state 602, etc.) or arcs (e.g., arc 604, etc.). In this example, the FSA pattern starts at state 602. As illustrated by arc 604, an event is dispatched for a medical order (“Medorder”). Responsive to the dispatch of the medical order event, the protocol expression transitions to state 1, as represented by state 606. As indicated above with respect to FIG. 4, verbs in the state are executed before waiting for an event to transition the protocol to another state. As indicated by the “Send” verbs, if the order is not stat, operations continue at 608 so the medication order is treated as a regular order. Otherwise, operations continue at state 2 (610) and the medication order is treated as a stat order. As illustrated by the states associated with 610, 614, 616, 618, 620, and 622, this exemplary executing protocol has seven distinct states, each state performing distinct actions as illustrated by the various events associated with arcs and indicators 624 through 626.

TABLE 1 provides exemplary pseudo code descriptions of the terms associated with the verbs of FIG. 6, according to one embodiment. The list of verbs is extensible, and one only needs to know that an appropriate list of verbs is associated with each state. Techniques to translate pseudo code into real code are well-known (e.g., syntaxes associated with Java, XML, BPEL, PERL, etc.). (THE REMAINDER OF THIS PAGE IS INTENTIONALLY LEFT BLANK)

TABLE 1
Table 1. End of exemplary pseudo code descriptions of
the terms associated with the verbs of FIG. 6.

| Verb | Meaning | Used in states |
|---|---|---|
| Get(event) | Incorporate into the FSA's execution context the | 6.1 (606), 6.4 |
| | properties associated with an event. | (614), 6.7 (620) |
| Read(k, v) | Read from the System's internal database into the | 6.1 (606) |
| | FSA's execution context a value v using key k. | |
| Write(t, k) | Write data from the FSA's execution context into | 6.1 (606) |
| | table t of the System's internal database using key | |
| | k. In state 6.1, this verb is used to write a | |
| | dayplanner record. Dayplanner is a table that the | |
| | nurse would use to review pending or upcoming | |
| | work events of which she needs to be aware. The | |
| | process of assembling the dayplanner record out of | |
| | the execution context is omitted in this example. | |
| | It's probably more illustrative if state 6.1 is revised | |
| | to read: | |
| | Write (Medorder, dayplanner, nurse). | |
| Test/Yes/No | This is a standard if-then-else construct. The truth | 6.1 (606), 6.3 |
| | value of the assertion in the parentheses after the | (612) |
| | Test keyword is evaluated and the sequence of | |
| | verbs after either the Yes or No keyword is | |
| | executed. | |
| Send(e, q) | Publishes an event of type e to queue q. If no queue | 6.1 (606), 6.3 |
| | is named, the event is sent only to the FSA's local | (612), 6.4 (614), |
| | event queue. | |
| Set | Set a timer to expire after interval of time x. When | 6.2 (610), 6.3 |
| timer(x, n) | a timer expires, it sends a timer expiration event to | (612), 6.4 (614), |
| | the executing FSA that set it. Timer expiration | 6.5 (616), |
| | events are indicated in the illustrations by the event | 6.6 (618), |
| | label Timesup. A timer optionally can have a name | 6.7 (620) |
| | n as well as an interval x. For named timers, the | |
| | name of the timer that expired is a property of the | |
| | Timesup event, i.e. Timesup.n. | |
| Set | Assigns a value to a variable in the execution | 6.2 (610) |
| | context of an FSA, including a property of a | |
| | received message (so that the message can be | |
| | forwarded in its altered state). | |
| Invoke | Causes the separate and independent execution of | 6.3 (612), |
| | another FSA. Parameters from the invoking FSA's | 6.5 (616) |
| | execution context can be passed to the new FSA's | |
| | execution context. | |
| Increase | Add 1 to the value of a numeric variable in the | 6.3 (612) |
| | FSA's execution context. Equivalent to Set: x = x + 1 | |
| Cancel(n) | Cancels the named timer. If no name is provided, | 6.4 (614), |
| | cancels all outstanding timers that were set by this | 6.5 (616), |
| | FSA. | 6.7 (620) |
| Chart(e) | Converts the event e to an HL7 event and publishes | 6.4 (614), |
| | it. | 6.7 (620) |

TABLE 2 shows an exemplary narrative of a protocol for processing a STAT medication order, according to one embodiment.

TABLE 2
EXEMPLARY NARRATIVE OF A PROTOCOL FOR
PROCESSING A STAT MEDICATION ORDER
Table 1. End of Narrative explaining STAT medication protocol.

| State | Context | Narrative |
|---|---|---|
| 1 | The Dispatcher has invoked this | The FSA loads the properties of the |
| | FSA as a result of having | triggering event into its execution |
| | detected on the Network an event | context, then uses one of the event |
| | representing a new medication | properties, Medorder.pat, to find |
| | order (Medorder). | which nurse is responsible for this |
| | | patient. The order is written into that |
| | | nurse's dayplanner. Then the FSA |
| | | tests another order property to |
| | | determine whether to give this order |
| | | priority (stat) or routine handling. |
| | | Only the STAT portion of this |
| | | protocol is shown; a ROUTINE order |
| | | would be processed similarly but |
| | | would use less aggressive timing and |
| | | alerting parameters. |
| 2 | Medorder properties are known; | Initialize a variable alertcount to track |
| | Identity of assigned nurse is | the number of times the nurse has |
| | known; order is STAT priority. | been paged about this order. Set a |
| | | timer to delay for a “grace period” |
| | | before paging the nurse. Possibly, the |
| | | nurse will notice the order on her day |
| | | planner promptly and not need to be |
| | | paged. Possibly, the order could be |
| | | canceled before the grace period is up, |
| | | in which case the protocol enters a |
| | | revocation sequence that is not |
| | | elaborated. |
| 3 | At least the grace period timer, | Test the value of the alertcount against |
| | and possibly additional timers, | a known constant alertmax which |
| | have expired. No notification | represents the maximum times a nurse |
| | from the nurse (Medadmin event) | should be paged before the situation is |
| | that the order has been carried out | escalated to a supervisor. If the |
| | has been received. System | alertcount has reached alertmax, |
| | context consists of the properties | invoke a new protocol to escalate the |
| | of all previously received events | issue and end this protocol. |
| | plus the current value of | Otherwise, invoke the protocol that |
| | alertcount. | pages the nurse (HighAlert), increase |
| | | the alertcount, and set another timer. |
| 4 | A Medadmin event associated | The FSA cancels any timers that may |
| | with this medication order has | be outstanding, loads the properties of |
| | been received. This is an | the Medadmin event into its context, |
| | acknowledgement by the nurse | and publishes the administration event |
| | that the Medorder has been | on the network so that it will be |
| | fulfilled. The nurse could have | entered into the patient's EMR. Now |
| | caused this event by | the protocol is complete and the FSA |
| | acknowledging the page on her | can Finish. |
| | mobile phone, or by entering the | |
| | order on her dayplanner web | |
| | page. System context consists of | |
| | the properties of all previously | |
| | received events plus the current | |
| | value of alertcount. | |
| 5 | A Cancel event has been | The FSA cancels any outstanding |
| | received, either from the nurse's | timers and loads the properties of the |
| | mobile phone in response to a | Cancel event into its execution |
| | page, or from the nurse's | context. It tests the authcode property |
| | dayplanner web page, indicating | of the original medication order to see |
| | that the nurse believes that the | if the nurse is authorized to cancel this |
| | dose should not be administered. | order without approval. If so, the |
| | System context consists of the | cancellation is charted and the |
| | properties of all previously | protocol completes. Otherwise, |
| | received events plus the current | another protocol is invoked to request |
| | value of alertcount. | authorization from the patient's |
| | | admitting physician. |
| 6 | The patient's doctor has been sent | The FSA sets a timer and waits to |
| | a request authorizing the nurse to | discover whether the doctor will |
| | omit administering the ordered | authorize the cancellation. If the |
| | medication. System context | timer expires, then the protocol |
| | consists of the properties of all | transitions into its exception follow-up |
| | previously received events plus | routine, which is not shown. |
| | the current value of alertcount. | |
| 7 | The patient's doctor has | The FSA cancels the outstanding |
| | authorized the cancellation. | timer and reads the cancellation order |
| | System context consists of the | into its context. It gets the needed |
| | properties of all previously | authorization out of the cancellation |
| | received events plus the current | order to enable it to chart the |
| | value of alertcount. | approved cancellation of the original |
| | | Medorder, and the protocol Finishes. |

TABLE 3
EXEMPLARY PARTIAL STATE TRANSITION TABLE FOR FIG. 6
Table 3. End of Partial State Transition Table for FIG. 6.

| From State | Transitional Event | To State |
|---|---|---|
| Start | Medorder (trigger event) | 1 |
| 1 | Routine | 8 (off diagram) |
| 1 | Stat | 2 |
| 2 | Cancelorder | 9 (off diagram) |
| 2 | Medadmin | 4 |
| 2 | Timesup | 3 |
| 3 | Timesup | 3 |
| 3 | Complete | Finish |
| 3 | Cancel | 5 |
| 3 | Cancelorder | 9 (off diagram) |
| 4 | Complete | Finish |
| 5 | Needauth | 6 |
| 5 | Complete | Finish |
| 6 | Timesup | 10 (off diagram) |
| 6 | Cancelorder | 7 |
| 7 | Complete | Finish |

A classic FSA is defined as above, by a State Transition Table. Each row in the State Transition Table represents an arc. A State Transition Table, plus the verb sequence (or script) to be executed upon entry to each state, comprises the entire static definition of an FSA. A State Transition Diagram, such as is shown in FIG. 6, completely defines the static FSA by itself, since the verb sequences are shown inside the boxes representing the states. The State Transition Diagram representation is preferred, especially for an automated Protocol Editor, because it is typically easier for a human being to conceptualize the represented process or protocol when viewing the State Transition Diagram.

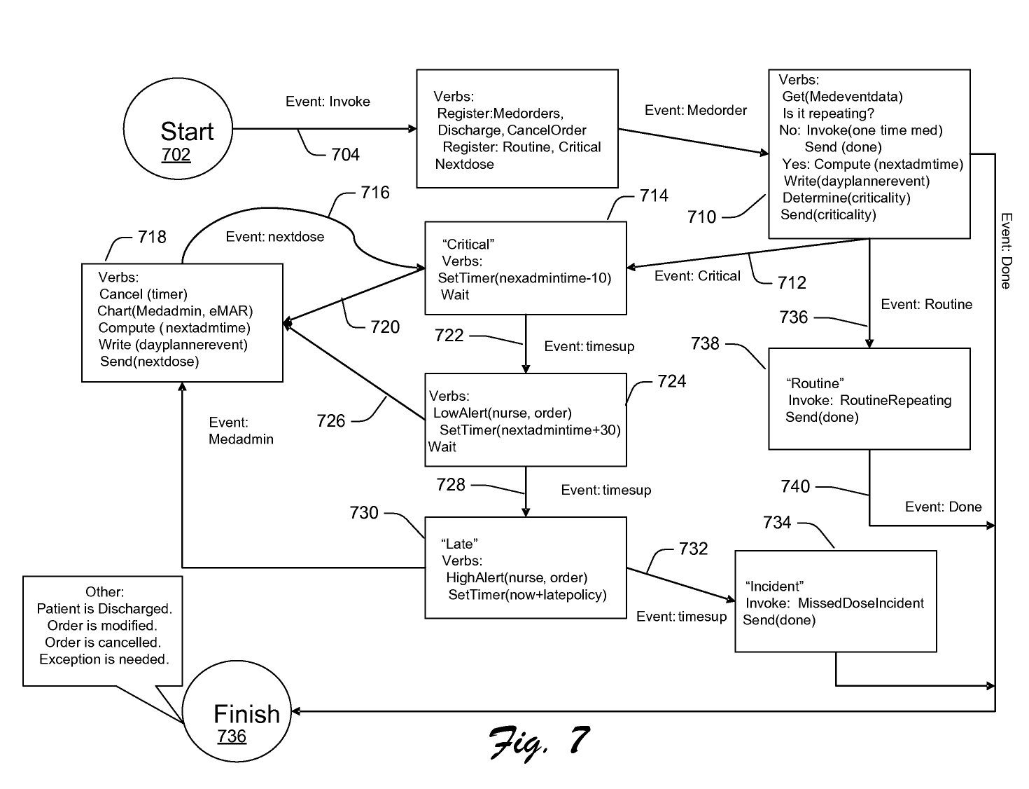

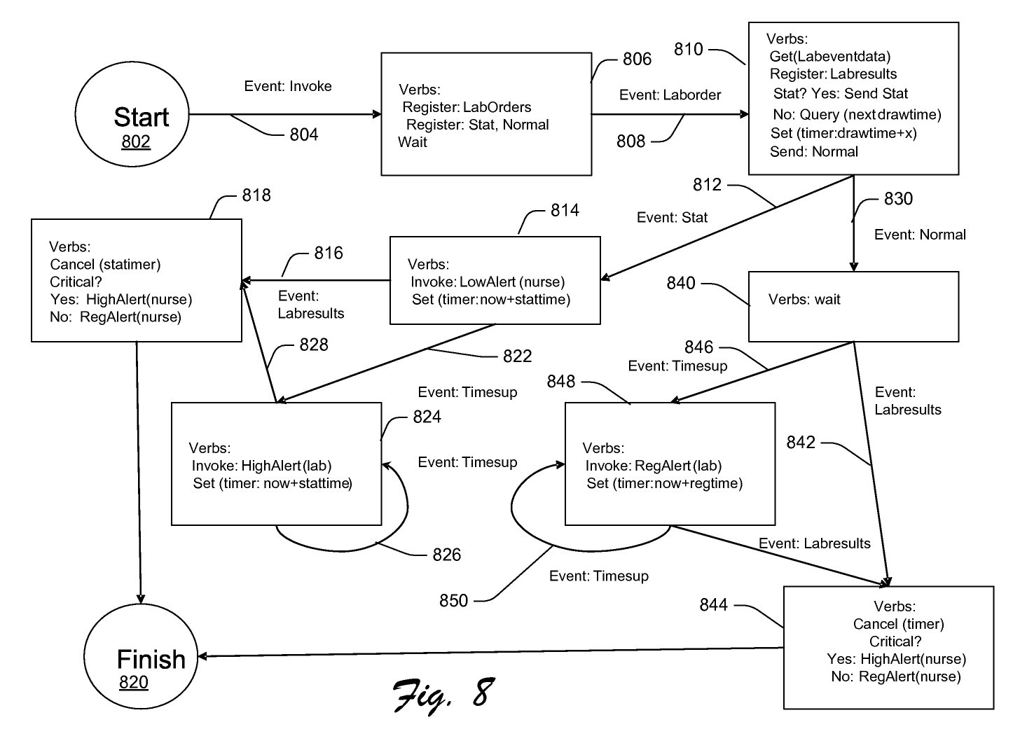

FIG. 7 shows an exemplary finite state automaton for repeating medication orders, according to one embodiment. FIG. 8 shows another exemplary finite state automaton, according to one embodiment. The FSA of FIG. 8 pertains to a protocol for laboratory results alerts.

### Exemplary Service Discovery and Subscription

In this exemplary implementation, configuration module 314 evaluates a protocol registry to identify the particular protocols defined by corresponding FSA patterns 322 (protocol expressions) that are available for execution. For purposes of exemplary illustration, such a protocol registry is shown as a respective portion of “other program data” 330. Configuration module 314 parses the corresponding FSA patterns to determine a list of specifics or characteristics of desired target services to provide input into corresponding ones of the protocols. Such target services are arbitrary and will be a function of the particular designs of the evaluated FSA patterns. Such target services may include, for example, services provided by EMR systems, diagnostics systems, monitoring systems, telecommunications devices, etc. In view of this list of target services, configuration module 314 determines which of the desired target services are available in the public/subscribe infrastructure of system 100. Such a target service in the context of system 100 corresponds to particular computer program application(s) executing (or available for execution) on one or more of data sources 116.

In one implementation, for example, configuration module 314 interrogates ESB middleware of enterprise messaging server 114 to identify a set of services available for data publication. In this implementation, the ESB middleware maintains a registry of services in system 100 that are available for another computer program application to subscribe to receive data publications. This registry of services further specifies corresponding message queues and events/messages published by respective ones of the services. Techniques for ESB middleware to allow computing devices and administrative entities to register system services in a published subscription environment are known. Moreover, techniques for ESB middleware to allow computer program applications to discover and subscribe to registered services are known.

Responsive to receiving information corresponding to available services in system 100, and for available services that match corresponding ones of the target services, configuration module 314 (not necessarily in this particular order) subscribes to receive data publications (i.e., data inputs 110) from the available services, and generates an event registry that maps triggering events associated with specific ones of the subscribed-to services to particular FSA patterns 322. Such an event registry is shown as a respective portion of “other program data” 330. As discussed above, associated with every protocol is a dispatch event (i.e., a respective triggering event, which is also a respective input datum 110). The association between protocol expressions (FSA patterns 322) and dispatch events is made using the event registry, for example, a two-column table generated by configuration module 314 mapping specific events to specific FSA patterns.

### Exemplary Event Dispatch

Event detection and dispatch logic 316 of health care management module 310, responsive to receiving a data input 110 evaluates the event registry to determine whether the data input is a triggering event that is mapped to a particular FSA pattern 322. If so, event detection dispatch module 316 creates a new protocol object with the operational and data characteristics of the particular FSA pattern in view of the triggering event. To this end, the protocol object, which is an executing protocol (i.e., a respective protocol execution instance 314), parses the particular FSA pattern to implement the pattern's operational characteristics (verbs). Each executing protocol is associated with a corresponding set of protocol data accumulated by the executing protocol up to its current execution state. For instance, an FSA pattern 322 and any information (e.g., a form, etc.) associated with the triggering event/message may represent the first parameter(s) to contribute to the protocol object's execution environment. The executing protocol in combination with its corresponding protocol data is called the protocol's execution context. Such protocol data is shown as a respective portion of “other program data” 330. Depending on the particular function of the protocol, the executing protocol may subscribe to one or more additional services published within system 100 to receive subscribed-to data input(s) 110 on corresponding message queue(s).

In one implementation, for example, event detection and dispatch module 316 implements a dispatch registry indicating particular messages/events of interest to registering executing protocols. In this manner, an executing protocol can receive desired events/messages from one or more data sources 116. In one implementation, for example, event detection and dispatch module 316 and/or an executing protocol 318 applies one or more filters to limit or throttle messages that an executing protocol receives. A filter can be expressed, for example, as a Boolean expression on the fields of a message. TABLE 4 illustrates exemplary filters (fn, where “n” is the particular filter).

TABLE 4
An Exemplary Message Queue Filter

f1: Deliver only messages of type <t>.
f2: Deliver only messages of type <t> where department=<y>.
f3: Deliver only messages of type <t> or <u> or <v>.
f4: Deliver all messages (null filter).

In one implementation, a filter is applied or subsequently altered by the executing protocol 318 (e.g., when the protocol subscribes to a message queue or at other times is dictated by the specifics of the protocol). In one implementation, health care management server 102 maintains a dispatch registry or table messages available to respective ones of executing protocols 318. Each entry in the dispatch registry includes, for example, indication(s) of the types of messages that subscribers (protocols) may expect to receive.

Characteristics of data output(s) 120 from an executing protocol for communication to a particular data sink 118, including identity of the data sink(s) to receive any such data output, are arbitrary. This is because such characteristics and identities are a function of one or more of the corresponding FSA pattern's particular implementation, static and/or dynamic aspects of resource model 320 that identifies and models interrelationships between respective logical and physical resources in the facility, and data sinks identified via respective ones on the enterprise messaging server 112 and communication server 114. In any event, and in one implementation, such data output 120 is substantially optimized for presentation on a targeted data sink 118.

### An Exemplary Procedure

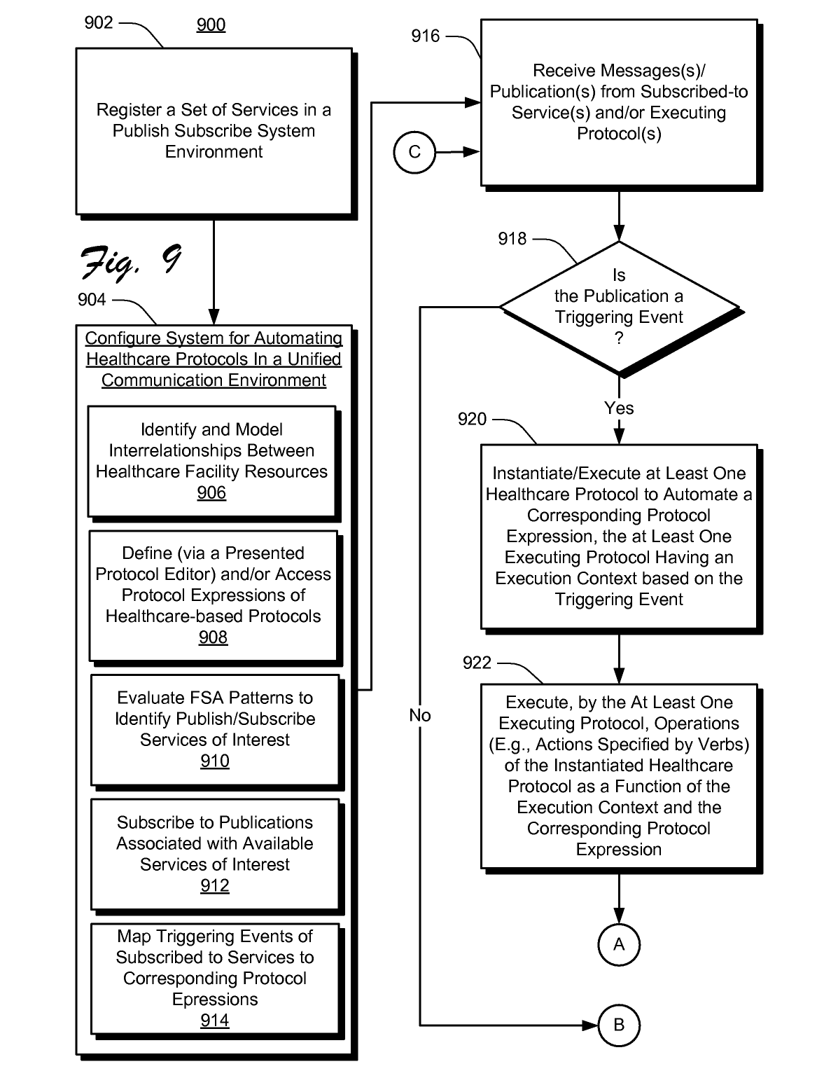

FIG. 9 shows an exemplary procedure 900 for automated execution of health care protocols in an integrated communications infrastructure, according to one implementation. For purposes of exemplary illustration and description, operations of procedure 900 are described with respect to aspects of FIGS. 1 through 8. In the description, the left-most numeral of a component reference number indicates the particular figure where the component was first introduced. In one implementation, operations of procedure 900 are implemented at least in part by respective computer program modules of computing devices in a health care management server 102 (FIG. 1).

Referring to FIG. 9, operations of block 902 register a set of services in a published subscribe system infrastructure. In one implementation, for example, such services are registered by respective data sources 116 with enterprise management server 112 (e.g., via Enterprise Service Bus middleware implementing a standardized set of messaging data formats and protocols). In one implementation, the communication server 114 also registers a communication service associated with data I/O from telecom devices coupled to the communication service over one or more telephone networks (e.g., PBXs and/or PSTNs). Operations of block 904 configure the system for automating health care protocols in a unified communication environment. In one implementation, for example, such operations configure health care management server 102 to automate health care protocols expressed by FSA patterns 322. In one implementation, these operations include operations associated with blocks 906 through 914 of FIG. 9, operations of which are now described.

Operations of block 906 identify system 100 resources and model interrelationships between the identified resources. These identification and modeling operations indicate properties and attributes of such resources for use by executing health care protocols (i.e., respective ones of protocol execution instances 318) to provide health care-related services to a patient according to a corresponding protocol expression (i.e., an FSA pattern). These health care-related services may involve establishing data communications between respective data sources 116 and data sinks 118, respective ones of which may correspond to telecom devices and/or computing devices operatively coupled to one another in the unified communication environment of system 100. In one implementation, configuration module 314 provides an administrative resource mapping interface through which an administrative entity can create a model of interrelationships (shown as resource model 320) describing the physical and logical resources of a health care facility—respective ones of at least a subset of the physical and logical resources affecting operations, or being used to implement operations of automated health care protocol executions.

Operations of block 908 define and/or access health care-based protocol expressions (FSA patterns 322) describing characteristics of health care-related protocols. Such characteristics provide context to the health care-related protocols. Such context causes an executing instance of a health care-related protocol to have a particular data execution context based on triggering events and the particular, but arbitrary, execution states and associated actions defined for the protocol. The particular execution states and associated actions, as well as the execution context, are arbitrary because they can be based on the particular function of the protocol. For instance, a protocol designed to administer a drug to a patient may have different data and execution contexts than a protocol designed to maintain electronic medical records for a patient from time of admission to a health care facility to time of discharge from the health care facility. In one implementation, the protocol expressions indicate characteristics associated with system publication services of interest to the protocol (the phrase “of interest to” meaning that an executing protocol based on the protocol expression is designed to process at least a subset of data publications [respective data inputs 110] from such a listed system publication service). Such characteristics include, for example, a list of messages published by such services that the protocol expression is designed to process. In one implementation, health care management server 102 provides a rules and protocol editor allowing an end user to define and edit an FSA pattern.

In one implementation, and as described below with respect to block 924, a protocol expression defined by the operations of block 908 may direct a corresponding executing health care protocol to evaluate one or more attributes and interrelationships between logical and physical resources associated with the message from a data source 116 or another executing protocol input into the executing health care protocol. Such evaluation may provide contextual background information about the received message, identification of target data sinks 118 to receive results or communications associated with the health care protocol operations, and/or so on.

Operations of block 910 evaluate FSA patterns 322 to identify the publish/subscribe services of interest to the protocol expression. In one implementation, such patterns are defined in a protocol registry maintained by health care management server 102. Operations of block 912 subscribe to publications associated with identified and available services of interest. Techniques to subscribe to such service publications are well-known. Operations of block 914 map triggering events of subscribed-to services to corresponding protocol expressions (FSA patterns). In one implementation, health care management server 102 determines messages of interest from each protocol expression. The health care management server 102 then generates a dispatch registry mapping particular ones of the events to the protocol expression such that, when the particular ones of the events are received by the health care management server 102, receipt of the event causes the health care management server 102 to instantiate a protocol based on the corresponding protocol expression. In one implementation, health care management server 102 passes the triggering event to the executing protocol (i.e., the instantiated protocol, which is also shown as protocol execution instance 318), and thereby provides at least one aspect of an initial execution-based data context to the executing protocol.

Operations of block 916 listen for and receive publications (data inputs 110) from subscribed-to services and/or executing protocols. In one implementation, such publications may be from an Electronic Medical Record system, a patient monitoring system, a diagnostic system, a person interacting with the communication device, and/or some other data source 116. Operations of block 918, responsive to receiving such publications, determine whether the publication is a health care protocol triggering event. In one implementation, health care management server 102 evaluates a dispatch registry to determine if the data input/publication is a triggering event.

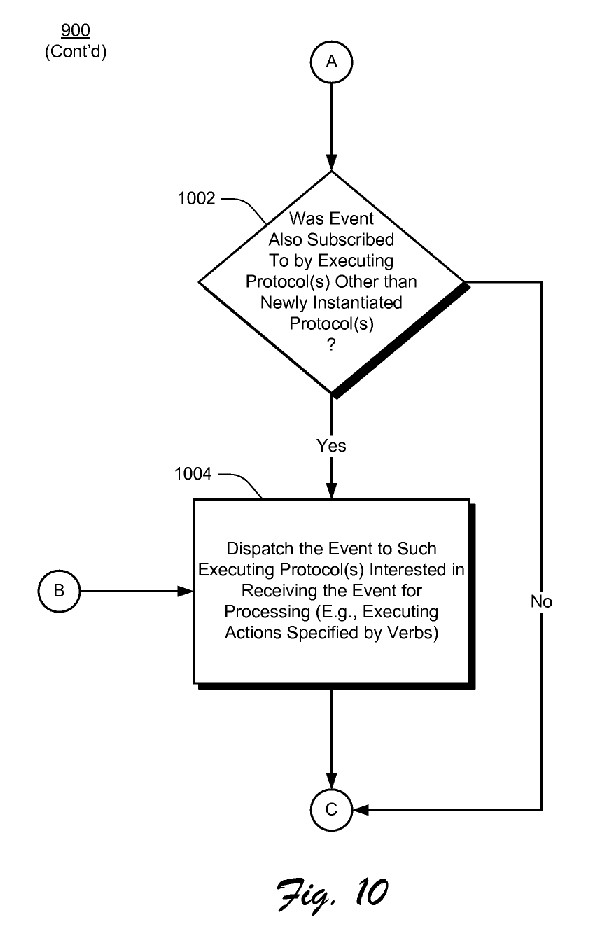

If the publication evaluated at block 918 is determined to be a triggering event, operations of procedure 900 continue at block 1002 of FIG. 10 (shown by on-page reference “B”), where the publication is dispatched to any executing protocol instance 318 interested in receiving the event for processing. (Operations of FIG. 10 are described below.) If the publication evaluated at block 918 is determined to be a triggering event, operations continue at block 920. At block 920, operations of procedure 900 select and instantiate a health care protocol expression corresponding to the triggering event. The selected protocol expression provides context to a newly instantiated/executed health care protocol. In one implementation, the health care protocol expression is an FSA pattern 322, and a protocol execution instance 318 is an instantiated and executing health care protocol that parses the corresponding FSA pattern to implement characteristics including actions specified by the protocol expression to provide health care-related services to a patient. Such services may be related to the health care of the patient either directly or indirectly. For example, the services may be associated with providing communications between a nurse and a doctor, where the communications pertain to some aspect of a standard of health care being applied to and/or otherwise related to the patient. In another example, the services may indicate how a health care provider is to administer medicine to the patient, implement a test on the patient, monitor vital signs of the patient, and/or so on. Operations of block 922 create an executing health care protocol that automates a protocol expression corresponding to the triggering event.

Operations of block 922 implement operations of the instantiated health care protocol (executing protocol 318) as a function of the corresponding triggering event and protocol expression (FSA pattern 322). Below are various examples of arbitrary operations implemented by an executing health care-based protocol as a function of its corresponding protocol expression. For purposes of exemplary illustration of instantiated health care related operations, several non-exhaustive examples of such operations are presented in the following section titled “Exemplary Health Care Use Cases.” These examples could be implemented as described below, or as part of more comprehensive sets of health care-based protocol actions. In these examples, notation may be made to whether features of the examples are resources within the system; corresponding components may be illustrated by reference number, etc. Omission of such notation does not mean that particular features are or are not system resources, components, etc. Subsequent to operations of block 922, procedure 900 continues at block 1002 of FIG. 10, as illustrated by on-page reference “A.”

FIG. 10 illustrates further exemplary operations of procedure 900 of FIG. 9 for automated execution of health care protocols in an integrated communications infrastructure, according to one implementation. Operations of block 1002 are executed subsequent to operations of block 922 of FIG. 9, as shown by on-page reference “A.” Referring to FIG. 10, block 1002, the procedure determines whether the triggering event (see block 918 of FIG. 9) is also an event subscribed to by one or more executing protocols (318). In this scenario, the one or more executing protocols (legacy protocols) are independent of the particular one or more healthcare protocols instantiated at block 920 of FIG. 9. If the triggering event was not subscribed to by any legacy protocols, procedure 900 continues at block 916 of FIG. 9, as shown by on-page reference “C.” If the triggering event was subscribed to by at least one legacy protocol, operations of block 1004 dispatch the event to the interested one or more executing legacy protocols. In one embodiment, operations of blocks 1002 and 1004 are performed prior to operations of blocks 920 and 922 of FIG. 9. After operations of block 1004, procedure 900 continues at block 916 of FIG. 9, as shown by on-page reference “C.”

In the embodiment described above, event dispatcher 316 (FIG. 3) receives at least a subset of all previously subscribed-to events for dispatch to the particular executing protocols that subscribed to receive the event(s). In this embodiment, the dispatcher sends the event to the interested protocols 318. In another embodiment, an executing protocol 318 automatically receives a subscribed-to event independent of the event dispatcher, for example, from enterprise message server 112 (FIG. 1). In this later scenario, if the event is not a triggering event (block 918 of FIG. 9), operations of procedure 900 flow directly from block 918 to operations of block 1004, independent of any intervening blocks.

Multithreaded and Event Driven Operations

Although the operations of procedure 900 have been described sequentially, it can be appreciated that processor 302 (FIG. 3) of healthcare management server 102 is a multiprocessor, and healthcare management module 310 is an event driven module. Thus, various operations of procedure 900, for example, operations associated with blocks 916 through 1004, may be implemented in parallel by different respective threads or processes depending on the types and timing of receipt of inputs 110 by healthcare management module 310.

### Exemplary Health Care Protocol Use Cases

Patient Admission to a Health Care Facility

In one implementation, a patient (a resource 320) is admitted to a nursing unit (resource). In this example, logic of health management server 102 has already subscribed to patient admission and discharge messages/publications from an Electronic Medical Records (EMR) system. In this particular implementation, for example, this subscription was made via Enterprise System Bus (ESB) middleware implementing HL7 standard messaging protocols on enterprise messaging server 112 of system 100. The admissions system (EMR system) sends out a corresponding HL7 message to signal such patient admission. Responsive to receiving the signal, logic of health care management server 102 determines whether or not the received signal is a triggering event (e.g., via an event registry). For example, was the patient admitted to a department (information that is provided by the signal/triggering event) managed by a health care facility associated with the health care management server 102? If the received signal is a triggering event, the logic instantiates a corresponding protocol to implement operations specified by a corresponding protocol expression (i.e., in this example, an FSA pattern 322) in view of information associated with the triggering event. If the event is not a triggering event, the logic dispatches the event to any already executing health care-based protocol (i.e., a respective protocol execution instance 318). Assuming that a corresponding protocol is instantiated, the triggering event providing the instantiated protocol's initial execution context, or an already executing protocol, receives the dispatched signal to process information associated with the signal according to the particular protocol expression.

Automatic EMR System Updates from a Telecom Device

In one implementation, for example, the health care protocol (i.e., a protocol execution instance 318) receives a publication from a communication service executing in system 100. In this example, the publication originates from a telecom device (a respective data source 116) that is operatively coupled to the communication service, which in turn is coupled to a telecommunications network (e.g., a PBX or PSTN) and a health care management server 102 that is hosting the executing health care protocol. The communication service is directly or indirectly configured to publish information from the telecom device to the health care management server 102. In this example, the executing health care protocol evaluates the publication to determine the set of attributes associated with the telecom device, wherein at least one of the attributes indicates an identity of an individual associated with the telecom device. At this point, and responsive to receiving the publication and subsequent determination of the identity, the health care protocol causes an observation regarding the individual to be charted in an Electronic Medical Records system (e.g., in a record pertaining to individual), wherein the observation was part of the data provided by the publication.

Automatic Detection of Mapped Devices for Communication

In another exemplary implementation, an executing health care protocol receives a message from a first person associated with the first communication device. This association is indicated by mapped interrelationships of logical and physical resources (e.g., see resource model 320) associated with system 100. The received message requests contact with a second person. Responsive to receiving this message, the executing health care protocol evaluates properties/attributes of one or more registered logical and physical resources in association with a health care facility to determine a particular communication device (e.g., a data source 116 and/or data sink 118) registered or otherwise in association with the second person. The executing health care protocol then causes a communication connection between the communication device associated with the first person and the communication device associated with the second person.

In another implementation, the health care protocol executing on health care management server 102 may identify one or more telecommunications endpoints (respective data sources 116 and/or data sinks 118) corresponding to logical and physical resources mapped to the health care facility (e.g., via resource model 320). In this scenario, the executing protocol communicates information corresponding to a particular situation or event to the telecommunications endpoint(s) associated with the persons.

Automatic Publication Subscriptions and State Transitions

In another implementation, exemplary operations associated with an executing health care protocol 318 (as specified by a respective protocol expression—e.g., an FSA pattern 322) include, for example, dynamically modifying a set of publications to be dispatched by a health care management server to the executing protocol. In another implementation, such operations may include transitioning from a first execution state associated with the first set of actions to a second execution state associated with a different set of actions. Such transitioning may be responsive to the satisfaction of predetermined criteria specified by the particular protocol expression directing data and execution characteristics of the health care protocol.

Alerting of Dynamically Determined Individuals

In another implementation, and again in reference to the operations of block 924 of FIG. 9, an executing protocol (i.e., a protocol execution instance 318) may notify, responsive to detecting a particular situation or event, a set of persons according to criteria specified by a corresponding protocol expression. The criteria may be based on one or more attributes of identified/registered health care facility resources (e.g., see resource model 320 of FIG. 3). For example, the criteria may specify a set of persons based on respective roles of each person (e.g., charge nurse, doctor, emergency responder, anesthesiologist, etc.), whether respective ones of the persons are on call and available, estimated time(s) of arrival, etc. Again, such an action is taken in view of the particular criteria set out by the corresponding protocol expression (FSA pattern 322). In addition to or independent of such notifications, the executing protocol may implement actions according to predetermined policy specified by the protocol expression. Such actions may be discretionary or nondiscretionary depending on the particular individual specified to implement the actions (e.g., a nurse may need to get authorization from a doctor, and/or so on). For example, the executing protocol may present an end user with instructions to administer a test or drug, cause patient observations to be charted, and/or send an order to a pharmacy or blood bank.

In another exemplary implementation, a nurse (the nurse/person being a resource, and the role of “nurse” being an attribute of the person/resource) uses a managed mobile handset (a respective data source 116 and possibly a data sink 118) to signal an emergency situation in a particular room (another resource). In this scenario, communication server 114 receives the signal, responsive to which it either forwards the signal to enterprise management server 112 for subsequent communication to health care management server 102, or alternatively, directly indicates the signal to health care management server 102. Health care management server 102, responsive to receiving the signal (a respective data input 110) issues one or more queries (data outputs 120 to a database 106 comprising resource model 320 to determine the ID of the patient [a resource] in the particular room and the phone number [an attribute of a data source 116 and a data sink 118] of that patient's admitting physician [another resource interrelated to a telecommunications device resource with a phone number attribute]). Responsive to such queries, this information is provided to health management server 102, and more particularly in this example, to an executing protocol to notify the admitting physician via the identified telecommunications device (and/or other device(s)) of the situation, further providing the automatically mined patient identifying information, location, and/or so on, to the physician.

Automatic EMR System Updates from a Telecom Device

For example, responsive to receiving a particular event (data input 110), an executing protocol may be configured to contact a first/next emergency responder on a call list for a particular role. At this point, the executing protocol may enter a timeout-protected wait for an acknowledgment from the responder. If the responder negatively acknowledges or times out before the executing protocol receives a response, the executing protocol attempts to contact a next responder (if any) in the list. If a responder acknowledges, then the executing protocol reports the response and estimated time of arrival to the originator of the particular event (or other specified entity), and updates an actual shift schedule and on call list to indicate that the particular responder is on the way. On arrival, the responder may check in with the health care management server 102 (e.g., see the example below describing “Exemplary Resource And Attribute Definition And Update”.) In a scenario where the responder call list is exhausted without retaining an acknowledgment from a responder, the executing protocol may report the failure to the originator of the particular event; alert the front desk and/or a department supervisor that a call in attempt has failed, etc.

In another exemplary implementation, an attending physician in a particular room confirms that emergency protocol should be carried out for a patient, signaling this confirmation via a handheld mobile device or other device (a data source 116). Responsive to receiving this confirmation data (a respective data input 110), an executing protocol 318 logs this confirmation data in an event log (a respective portion of “other program data” 330). In addition, the executing protocol may generate an event (e.g., an HL7 event) describing the situation. In this scenario, an EMR system (a data source and data sink operatively coupled to the server 102) has subscribed to receive such an event. The EMR system, responsive to receiving the event, may chart the event in the patient's permanent record.

Depending on the particular implementation of a protocol expression, a log maintained by health management server 102 and/or a particular executing protocol 318 may include arbitrary sets of information. Such information may include, for example, logged events such as: call dialed, call completed, rule executed, rule canceled, directory access request, etc. In another example, a log may also summarize information, for example: counts and durations of manually dialed calls from each managed handset, number and duration of alias-invoked (speed dialed) calls from each handset, number of rules executed via a function key from a managed handset, number of rules executed from a computer form, number of dialed calls that were not picked up, number of text messages sent, number of directory accesses made by phone, number of each type of communication executed by a rule, etc.

Exemplary Health Care Facility Directory Presentation

In one implementation, the logic of health care management server 102 (e.g., an executing protocol 318) provides directory information to end users requesting such information, for example, via any text-capable endpoint (data source 116), including phones and computing devices. Such directory information includes, for example, shift directory information, schedule views, list department directories, on call directories, reminders lists, etc. Shift directory information includes, for example, names of check-in staff members, staff members' roles, corresponding speed dial codes, extensions, location, responsibilities by room number, time remaining in status, check-in times or scheduled arrival times, scheduled departure times, contact preferences, etc. A “List Department Directory” includes, for example, department names, locations (e.g., site-specific, such as floor, wing, etc.), extensions, etc. An “On Call Directory” includes, for example, information associated with individuals designated as available to respond to certain types of situations. An on call person may or may not be also on shift. In this implementation, for example, an on call directory presentation includes role names, role-based speed dial capabilities, indications of a number of responders available and on call for a particular role, estimated response times, respective statuses (e.g., check in, available, called, on the way, busy, etc.), and primary and secondary contact methods (e.g., cell phone, landline, internal extension, pager, etc.). In one implementation, for example, an FSA pattern 322 (protocol expression) designed to present such an “on call directory” responsive to receipt of corresponding event(s) may include verbs such as “Call”, “Detail”, etc., to allow a requestor to automatically contact a responder, determine more detail corresponding to a responder, etc.

Exemplary Resource and Attribute Definition and Update

In one implementation, an executing protocol (a protocol execution instance 318) allows an end user to register resources and/or change attributes of resources within resource model 320 from any capable data source 116 (e.g., pooled mobile endpoints, etc.). For example, a staff member may desire to notify health management server 102 that the individual: is on duty, can be reached via a particular speed dial code, will be late, will be unavailable, requests to be removed/added from an on call list for a designated shift, is available/unavailable to be assigned to a particular shift, etc., so that corresponding shift directories, whiteboards, etc. can be updated by the executing protocol.

To this end, for example, the staff member may enter a check-in sequence along with a personal identifier (a code or PIN) into a data source 116, causing a corresponding event to be generated and communicated to health care management server 102. As in the previous examples, if an executing protocol is not already instantiated to process such registration and resource information definition or updating events (via a predefined protocol expression), the server will instantiate one to implement the corresponding protocol expression, passing the event and associated information to the executing protocol. The particular registration/updating activities performed at this point by the protocol are arbitrary.

For example, in one implementation, the protocol may ensure that several preconditions are met (e.g., the registrant/updater is privileged to perform the requested action, the data sources/endpoint is assigned to the target department, the individual is scheduled in the department for the indicated shift, etc.). If the preconditions are met, the protocol may make the following state changes: associate an indicated departmental speed dial code with the corresponding data source (e.g., an endpoint extension), add the extension to the call list for all role-based speed dial codes that the shift schedule associates with this individual, add the individual to the actual shift directory for a particular department (e.g., specified by the event), indicate that the individual is available, specify the individual's role/responsibilities, request the individual to confirm such changes, perform exception handling, post a change event so that whiteboards and any other affected displays within the health facility's network are automatically refreshed by an executing protocol with updated information regarding the individual, etc.

In another example, each hospital or department may determine by policy whether shift checkout is required—this policy is appropriately defined in a corresponding protocol expression or otherwise fetched from a data store by the protocol expression. In one implementation, for example, if checkout is not required, then an executing protocol based on the corresponding protocol expression automatically removes a staff member from a shift directory, disables his individual speed dial, and removes the staff member from all role-based call lists automatically at the end of the staff member's scheduled work period.

Exemplary Whiteboard Protocol

In one implementation, system 100 includes an FSA pattern 322 for a whiteboard protocol. In this implementation, for example, the protocol expression defines a query for an executing protocol to determine a whiteboard's particular configuration (row and column layout), determines what events cause the whiteboards to refresh, and associates the protocol with one or more displays (resources), e.g., via registering to receive specific events. The query that defines a whiteboard is a query against one or more databases on the network—such a query could include the present system's internal database joined with data from the EMR via the MFQ message (e.g., see TABLE 1), for example. The FSA, for example, executes the defining whiteboard query, displays the resulting data on all associated endpoints (the actual screens where the whiteboards display), and begins to listen for events that would indicate a change in the contents of the whiteboard. In one implementation, the set of events capable of altering the whiteboard display are defined by a filter. When a significant event is received, the FSA would repeat the defining query and write the new data to each endpoint that is displaying “this” whiteboard.

Exemplary Reminder Protocol

In one implementation, an FSA pattern 322 provides a protocol for reminders. Such a health care-based reminder protocol may include, for example, events that registrants desire to know about. In one implementation, responsive to sending or receiving an alert, having one's shift status responsibility changed by a supervisor, etc., the reminder protocol automatically inserts reminder information into a reminders list for a registrant. Such reminders are arbitrary and may include, for example, the time to administer medication to a particular patient in a particular room, the need to respond to an alert, etc.

Exemplary Alert Response Listening Protocol

In one implementation, system 100 for automated execution of health care protocols in an integrated communications infrastructure provides adaptive mechanisms to encourage alert recipients to acknowledge alerts, and by doing so provide as much information as possible to members of a response team. An alert response is an event that updates an executing protocol's state. Whiteboards, console agents, etc., may display alert status reports. In one implementation, alert responses are added to an alert initiator's reminder list. There are many possible mechanisms for enabling alert responses, even from devices that are not particularly capable of providing such responses, such as one-way numeric pagers, and/or so on, as described below.

In one implementation, an FSA pattern 322 is designed to monitor one or more alert response extensions (pathways, queues, etc.) and perhaps also an SMS destination for alert responses. Alerts to text-capable external mobile phones may contain phone numbers for click-to-call responses, possibly including a different number for an acknowledgment (“ack”) and a negative acknowledgment (“nack”). In one implementation, an alert protocol records an alert response according to a call event and caller ID combination. In one implementation, an alert protocol identifies text alerts from phone forms, simple text that programs a phone's soft keys for an instant ack/nack. In one implementation, an alert or reminder includes links to an externally accessible website. In one implementation, the links are dynamically created by an executing protocol to identify the specific alert and responder. Following the link will result in the responder seeing a form specific to the alert to acknowledge the alert positively or negatively, provide an estimated time of arrival, possibly answer questions (e.g., authorize medication to be administered before the doctor arrives, etc.), enter text or record a message for communication to onsite responders, and/or so on.

### Conclusion

Although the above sections describe automated execution of health care protocols in an integrated communications infrastructure in language specific to structural features and/or methodological operations or actions, the implementations defined in the appended claims are not necessarily limited to the specific features or actions described.

For example, although health care management server 102 (e.g., see FIG. 3) is described as comprising a set of program models for online rules-based execution of standard of care protocols in the integrated and networked communications infrastructure of system 100, various aspects of the health care management server 102 may be implemented in a distributed computing environment by one or more other computing devices. In this scenario, certain operations described above regarding health care management server 102 would run on multiple computing devices in distributed fashion. For instance, one or more other computing devices remote to the health care management server 102 may host one or more arbitrary protocol execution instances (e.g., responsive to inputs received from health care management server 102, responsive to inputs from a data source 116, etc.). Such an other computing device, for purposes of exemplary illustration, may be represented by a computing device such as health care management server 102 with similar, different, a subset, or other program module and data configurations as described above with respect to health care management server 102. Additionally, other examples and scenarios within the context of the descriptions described above for health care management server 102 online rules-based execution of standard of care protocols in the integrated and networked communications infrastructure of system 100 are also contemplated within the scope of this description.

In another example, the health care management server 102 may execute one or more protocols to manage long-running therapies. In this example, at least a subset of the protocols alert care providers, for example, when lab tests are required, when tests results are available, present orders for dosage adjustments, direct care provider(s) to cease therapy, convert alert responses into medical charting events, and/or so on. The long-running therapies include, for example, the administration of anti-coagulants, insulin, pain control (opiates), sedatives, and/or so on.

Accordingly, the specific features and operations for automated execution of health care protocols in an integrated communications infrastructure are disclosed as exemplary forms of implementing the claimed subject matter.

1. A computing device networked to other computing devices and a set of telecommunications (“telecom”) devices, the computing device comprising:
at least one processor; and
a memory coupled to the at least one processor, the memory comprising computer program instructions executable by the processor, the computer program instructions when executed by the processor performing operations comprising:
(a) receiving, by the computing device, a message from one of the other computing devices, a telecom device, or an executing health care protocol;
if the message is a health care protocol triggering event (“triggering event”):
(b) identifying, by the computing device, a protocol expression mapped to the triggering event, the protocol expression being based on a standard of health care; and
(c) executing, by the computing device, a health care protocol with context based on the protocol expression and the triggering event, the context causing the health care protocol to implement actions associated with providing health care to a patient, the context indicating a set of publication(s) from system publication service(s) or executing protocol(s) to be dispatched upon receipt to the health care protocol to provide at least a subset of the health care to the patient; and
if the message is a publication of the publication(s):
(d) dispatching the message to any executing health care protocol previously indicating interest in receiving such a message for processing based on a corresponding protocol expression.

2. The computing device of claim 1 wherein the computing device is operating in a distributed computing environment, and wherein at least one other computing device in the distributed computing environment implements one or more of the operations of (a), (b), (c), and/or (d).

3. The computing device of claim 1 wherein the message is from: (a) an Electronic Medical Record (EMR) system; (b) a patient monitoring system; (c) a diagnostic system; or (d) a person via interaction with a communication device.

4. The computing device of claim 1 wherein the computer program instructions further comprise instructions to execute one or more protocols to manage long-running therapies, at least a subset of the one or more protocols alerting care providers when lab tests are required, when tests results are available, presenting orders for dosage adjustments, directing cessation of therapy, and/or converting alert responses into medical charting events, where the long-running therapies include one or more of administration of anti-coagulants, insulin, pain control (opiates), and sedatives.

5. The computing device of claim 1 wherein the computer program instructions further comprise instructions for dynamically modifying, by the health care protocol, the set of publication(s) to be dispatched upon receipt to the health care protocol.

6. The computing device of claim 1 wherein the computer program instructions further comprise instructions for transitioning, by the health care protocol and responsive to receipt of at least one message, from a first execution state associated with a first set of actions to a second execution state associated with a different set of actions responsive to satisfaction of predetermined criteria specified by the protocol expression, and wherein the transitioning is responsive to receipt of at least one message.

7. The computing device of claim 1 wherein the computer program instructions further comprise instructions for:
presenting, by the computing device, a protocol editor to an end user to allow the end user to define the protocol expression; and
wherein an event registry maps a triggering event of a system publication service to the protocol expression.

8. The computing device of claim 1 wherein the protocol expression directs the health care protocol, prior to implementing a set of operations associated with a particular execution state, to evaluate one or more of attributes and interrelationships between one or more of logical and physical resources associated with a health care facility to determine one or more of background information associated with the message and to determine appropriate target data sink(s) to receive results of the operations, the target data sink(s) corresponding to particular ones of the logical and physical resources.

9. The computing device of claim 1 wherein the computer program instructions further comprise instructions for:
receiving, by the health care protocol, a publication of the publication(s) from a service of the system publication service(s), the publication originating from a telecom device operatively coupled to the service, the service being coupled to a telecommunications network and the computing device, the service being configured to directly or indirectly publish information from the telecom device to the computing device;
evaluating, by the health care protocol, the publication to determine a set of attributes associated with the telecom device, at least one of the attributes indicating an identity of an individual associated with the telecom device; and
responsive to receiving the publication and subsequent to determining the identity, causing, by the health care protocol, information to be charted into a record of an Electronic Medical Records system, the information being an observation indicated by the publication, the record pertaining to a patient, and/or the health care protocol being associated with the patient.

10. The computing device of claim 1 wherein, prior to operations associated with receiving the message, identifying the protocol expression, executing the health care protocol, and dispatching the message, the computer program instructions further comprise instructions for:
identifying and modeling, by the computing device, logical and physical health care facility resources and interrelationships therebetween, the logical and physical health care facility resources being utilized by the health care protocol according to one or more of dynamic and static criteria; and
receiving, via a protocol, by the computing device, a set of dynamic criteria indicating resource registration information to register a person as a health care facility resource, the resource registration information having been communicated to the computing device responsive to a person inputting an identifying key sequence into a communication device, the communication device being a respective resource of the health care facility resources, the respective resource having been identified responsive to operations associated with identifying and modeling the logical and physical health care facility resources and interrelationships therebetween.

11. The computing device of claim 10 wherein the computer program instructions further comprise instructions for:
receiving, by the health care protocol, a message from a first person associated with a first communication device, the message requesting contact with a second person;
responsive to receiving the message, evaluating, by the health care protocol, properties of one or more of registered logical and physical resources in association with the health care facility to determine a second communication device registered to the second person;
causing, by the health care protocol, a communication connection between the first and second communication devices; and
wherein operations associated with evaluating the properties and causing the communication connection are specified by the protocol expression.

12. The computing device of claim 1 wherein, prior to operations associated with receiving the message, identifying the protocol expression, executing the health care protocol, and dispatching the message, the computer program instructions further comprise instructions for:
identifying and modeling, by the computing device (1) data sources and corresponding publications, and (2) data sinks and corresponding subscriptions, the publications and subscriptions being utilized by the health care protocol; and
subscribing, by the computing device, to at least a subset of the publications from system publication service(s) associated with the data sources.

13. The computing device of claim 1 wherein the computer program instructions further comprise instructions for one or more of the following operations by the health care protocol:
retrieving data relevant to one or more executing protocols to communicate the data to one or more of telecom devices and data presentation devices;
implementing a sequence of actions associated with a healthcare workflow according to a predetermined policy specified by the protocol expression;
presenting an end user with directory information, the directory information comprising one or more of shift directory information, schedule information, department information, and on call information;
responsive to receipt of an event that is associated with content of a whiteboard, updating information on the whiteboard according to the specific presentation characteristics of the whiteboard;
updating an individual's reminder list with information that pertains to the individual;
listening for alert responses on multiple different alert response extensions to determine whether target individual(s) are responding to a particular situation, and to indicate corresponding information associated with individual(s) responding to a particular situation;
checking out a staff member from a shift at the end of a predetermined shift schedule and updating any associated resources to indicate such a checked out status;
responsive to receiving a resource registration or update event, registering or updating information associated with the event, and notifying any interrelated data sinks and electronic documents of newly registered or updated information;
presenting an end user with instructions or orders specified by the protocol expression on how to administer a test, drug, or carry out any manual healthcare procedure, and receiving an acknowledgement from the end user indicating whether the end user implemented the instructions or orders;
causing patient observations to be charted;
sending an order to a pharmacy, blood bank, or laboratory;
speed-dialing an individual based on a role;
sending scheduled alerts to data sinks; and
adaptively routing alerts based on one or more of workload, status, and negative or missing acknowledgments associated with target responder(s).

14. The computing device of claim 1 wherein the computer program instructions further comprise instructions for one or more of the following operations by the health care protocol responsive to receiving an update event representing: an order to administer a drug, a pharmacy or laboratory order, receipt of lab results, or patient monitoring results, updating information associated with the event, and notifying any interrelated data sinks and electronic documents of information associated with the update event.

15. The computing device of claim 1 wherein the computer program instructions further comprise instructions for notifying, by the health care protocol, responsive to a detected situation or event, a set of persons according to criteria in the protocol expression, the criteria being based on one or more attributes of health care facility resources.

16. The computing device of claim 15 wherein the computer program instructions further comprise instructions for identifying, by the health care protocol according to context specified by the protocol expression, the set of persons based on respective roles of each person in the set of persons.

17. The computing device of claim 15 wherein the context directs the health care protocol to notify the set of persons by performing the following operations:
identifying one or more telecommunications endpoints corresponding to one or more of logical and physical resources in a health care facility; and
communicating information corresponding to the particular situation or event to the one or more telecommunications endpoints.

18. A computer-readable data storage medium comprising computer program instructions executable by a processor, the computer-program instructions, when executed, causing a computing device networked to other computing devices and a set of telecommunications (“telecom”) devices to perform operations comprising:
(a) receiving, by the computing device, a message from one of the other computing devices, a telecom device, or an executing health care protocol;
if the message is a health care protocol triggering event (“triggering event”):
(b) identifying, by the computing device, a protocol expression mapped to the triggering event, the protocol expression being based on a standard of health care; and
(c) executing, by the computing device, a health care protocol with context based on the protocol expression and the triggering event, the context causing the health care protocol to implement actions associated with providing health care to a patient, the context indicating a set of publication(s) from system publication service(s) or executing protocol(s) to be dispatched upon receipt to the health care protocol to provide at least a subset of the health care to the patient; and
if the message is a publication of the publication(s):
(d) dispatching the message to any executing health care protocol previously indicating interest in receiving such a message for processing based on a corresponding protocol expression.

19. The computer-readable data storage medium device of claim 18 wherein the computer program instructions further comprise instructions for dynamically modifying, by the health care protocol, the set of publication(s) to be dispatched upon receipt to the health care protocol.

20. The computer-readable data storage medium of claim 18 wherein the computer program instructions further comprise instructions for transitioning, by the health care protocol and responsive to receipt of at least one message, from a first execution state associated with a first set of actions to a second execution state associated with a different set of actions responsive to satisfaction of predetermined criteria specified by the protocol expression, and wherein the transitioning is responsive to receipt of at least one message.

21. The computer-readable data storage medium of claim 18 wherein the computer program instructions further comprise instructions for:
receiving, by the health care protocol, a publication of the publication(s) from a service of the system publication service(s), the publication originating from a telecom device operatively coupled to the service, the service being coupled to a telecommunications network and the computing device, the service being configured to directly or indirectly publish information from the telecom device to the computing device;
evaluating, by the health care protocol, the publication to determine a set of attributes associated with the telecom device, at least one of the attributes indicating an identity of an individual associated with the telecom device; and
responsive to receiving the publication and subsequent to determining the identity, causing, by the health care protocol, information to be charted into a record of an Electronic Medical Records system, the information being an observation indicated by the publication, the record pertaining to a patient, and/or the health care protocol being associated with the patient.

22. A computing device networked to other computing devices and a set of telecommunications (“telecom”) devices, the computing device comprising processing means for:
(a) receiving a message from one of the other computing devices, a telecom device, or an executing health care protocol;
if the message is a health care protocol triggering event (“triggering event”):
(b) identifying a protocol expression mapped to the triggering event, the protocol expression being based on a standard of health care; and
(c) executing a health care protocol with context based on the protocol expression and the triggering event, the context causing the health care protocol to implement actions associated with providing health care to a patient, the context indicating a set of publication(s) from system publication service(s) or executing protocol(s) to be dispatched upon receipt to the health care protocol to provide at least a subset of the health care to the patient; and
if the message is a publication of the publication(s):
(d) dispatching the message to any executing health care protocol previously indicating interest in receiving such a message for processing based on a corresponding protocol expression.
